(19) United States
(12) Patent Application Publication
(10) Pub. No.: US 2010/0313034 A1
(43) Pub. Date: Dec. 9, 2010

(54) INFORMATION PROCESSING APPARATUS, DATA RECORDING SYSTEM, INFORMATION PROCESSING METHOD, AND PROGRAM

(75) Inventors: Susumu SENSHU, Kanagawa (JP); Takahiro Toyoda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/707,939

(22) Filed: Feb. 18, 2010

(30) Foreign Application Priority Data
Jun. 3, 2009 (JP) P2009-052854

(51) Int. Cl. G06F 12/14; G06F 21/00

(52) U.S. Cl. 713/185; 713/193; 726/9; 711/E12.092

(57) ABSTRACT

An information processing apparatus includes an authentication section that executes authentication with a first recording medium, and a decryption section that executes decryption of encrypted data stored on a second recording medium. The decryption section acquires data stored on the first recording medium on the condition that authentication with the first recording medium is established, and performs decryption of encrypted data recorded on the second recording medium by using the acquired data.

### BACKGROUND OF THE INVENTION

1. Field of the Invention

The present invention relates to an information processing apparatus, a data recording system, an information processing method, and a program. More specifically, the present invention relates to an information processing apparatus, a data recording system, an information processing method, and a program, which realize usage control of content stored on a data recording medium (information recording medium).

2. Description of the Related Art

Discs such as a DVD (Digital Versatile Disc) and a Blue-ray Disc (registered trademark) are used as content recording media. For example, movie content and the like are recorded on discs (e.g., ROM discs) and provided to users. In many cases, the copyrights, distribution rights, and the like of these disc-recorded contents belong to their creators or vendors. For such content, a certain usage control configuration is adopted to prevent unauthorized copying (duplication), for example.

Exemplary manufacture and playback of a content-storing disc will be described with reference to FIG. 1. FIG. 1 shows, from the left, a recording-data generating section 10 that generates data to be stored onto a disc, a disc plant 20, a disc 30, and a playback device 40.

The recording-data generating section 10 generates recording data such as encrypted content to be stored onto the disc 30. Processing executed by the recording-data generating section 10 will be described.

First, in step S11, the recording-data generating section 10 processes an MKB (Media Key Block) 11, which stores a media key used for decryption of disc-recorded content, as encrypted data, thereby extracting a media key (Km) 12.

Further, in step S12, a work key (Kw) 14 is generated by cryptographic processing using the media key 12 extracted from the MKB 11, and a volume ID 13 recorded on a disc as identification information for the disc. It should be noted that a volume ID is identification information that is set with respect to a set of a plurality of discs storing content of the same title, for example. Unlike general data, a volume ID is recorded by a special write process.

Next, in step S13, a content key 15 used for content encryption is decrypted with the work key (Kw) 14, generating an encrypted content key 16.

Further, in step S14, an encryption using the content key 15 is applied to content 17, generating encrypted content 18.

The MKB 11, the volume ID 13, the encrypted content key 16, and the encrypted content 18 are supplied to the disc plant 20 and recorded onto a disc. The disc plant 20 creates a master disc with these pieces of data set as recording data, and thereafter, executes a process such as stampering to generate a large number of discs.

The disc 30 thus generated is shown in the drawing. The disc 30 stores an MKB (media Key Block) 31, a volume ID 32, an encrypted content key 33, and encrypted content 34.

In the playback device 40, the disc 30 is inserted in a drive 41, and content is played back in accordance with a predetermined sequence. Processing performed by the playback device 40 will be described.

First, in step S21, the playback device 40 executes processing (decryption) of the MKB 31 with a device key 42, which is a device unique key held in a memory in advance, thereby acquiring a media key 43.

Next, in step S22, cryptographic processing is executed by using the media key 43 acquired from the MKB 31, and the volume ID 32 read from the disc 30, thereby generating a work key 44.

Further, in step S23, the generated work key 44 is used to execute decryption of the encrypted content key 33 read from the disc 30, thereby acquiring a content key 45.

Lastly, in step S24, the content key 45 is used to execute decryption of the encrypted content 34 read from the disc 30, thereby acquiring and playing back content 46.

In the case of a ROM-type disc that does not permit additional writing of data, encrypted content, and key information, a volume ID, and the like used for playback of the content can be recorded together on the disc and provided to the user. Therefore, the correspondence between a disc, and content, key information, and a volume ID is guaranteed with reliability. Thus, provided that strict management is implemented at the disc plant where data writing is performed, in many cases, unauthorized content use can be prevented.

That is, in the case of using the ROM disc shown in FIG. 1, to play back content, it is necessary to read a volume ID. This volume ID is written in a scheme different from that of general data. That is, the volume ID is data that does not allow writing by the user. Therefore, for example, even when content, key information, and the like are copied to another disc, since the volume ID recorded on the original disc is not recorded on the destination disc, it is not possible to perform content playback.

In this way, under a configuration in which a content-recorded ROM disc is manufactured at a plant and provided to the user, unauthorized content use can be effectively prevented.

However, in these days, a form of content provision is becoming increasingly common in which user-selected content is written onto a data-writable disc such as an R-type or RE-type disc and provided to the user. For example, by using a terminal installed in a public space, a store, or the like, the user selects content, and the selected content is recorded onto a data-writable disc on the spot and provided to the user. Alternatively, by using a user's terminal such as the PC of the user, content downloaded via a network is written onto a data-writable disc for use.

In such an on-demand content provision process, content is recorded onto an arbitrary disc purchased by the user. In this case, recording of data onto the disc is performed only with respect to a general data-recording area. That is, the above-mentioned volume ID or the like is not recorded by a special write process. Therefore, in the case of such an on-demand content provision process, unlike the content-recorded ROM disc described above with reference to FIG. 1, it is not possible to maintain the correspondence between the volume ID and content, making it difficult to perform strict content control.

As a configuration for solving this problem, Japanese Unexamined Patent Application No. 2007-133608, or Japanese Unexamined Patent Application No. 2005-316994 describes a configuration in which an IC chip is embedded in a disc and identification information is written in the IC chip or an RFID tag. However, discs embedded with such special recording elements increase in cost, which makes it difficult to promote users to use such discs, leading to a decrease in the willingness of general users to buy content.

### SUMMARY OF THE INVENTION

It is desirable to provide an information processing apparatus, a data recording system, an information processing method, and a program which prevent unauthorized use of disc-recorded content, and enable strict content usage control, in the case of a configuration in which the user records arbitrary content onto a data-writable disc for use.

According to an embodiment of the present invention, there is provided an information processing apparatus, including an authentication section that executes authentication with a first recording medium, and a decryption section that executes decryption of encrypted data stored on a second recording medium, in which the decryption section acquires data stored on the first recording medium on a condition that authentication with the first recording medium is established, and performs decryption of encrypted data recorded on the second recording medium by using the acquired data.

Further, in an information processing apparatus according to an embodiment of the present invention, the first recording medium is an IC card or a USB token, and the second recording medium is a disc on which encrypted content is recorded.

Further, in an information processing apparatus according to an embodiment of the present invention, the second recording medium stores encrypted content and identification information of the encrypted content, the first recording medium stores identification information of the encrypted content, the information processing apparatus executes a comparison of the identification information acquired from both the first recording medium and the second recording medium, and the decryption section performs decryption of encrypted content recorded on the second recording medium, on a condition that both the identification information match.

Further, in an information processing apparatus according to an embodiment of the present invention, a signature is set for the identification information of the encrypted content stored on the second recording medium, and the information processing apparatus performs verification of the signature, and performs the comparison if it is confirmed that the identification information is data that has not been tampered with.

Further, in an information processing apparatus according to an embodiment of the present invention, the first recording medium stores a usage status flag indicating a usage status of data recorded on the second recording medium in the information processing apparatus, and the information processing apparatus determines whether or not the usage status flag is set to a valid value indicating a state in which use of the data recorded on the second recording medium by the information processing apparatus is permitted, and performs decryption of encrypted content recorded on the second recording medium on a condition that setting of the valid value is confirmed.

Further, in an information processing apparatus according to an embodiment of the present invention, the second recording medium stores encrypted content, the first recording medium stores a content key used for decryption of the encrypted content, and the decryption section performs decryption of the encrypted content by using the content key.

Further, in an information processing apparatus according to an embodiment of the present invention, the second recording medium stores encrypted content, and an encrypted content key that is encrypted data of a content key used for decryption of the encrypted content, the first recording medium stores a volume key used for decryption of a plurality of encrypted content keys including the encrypted content key, and the decryption section acquires the content key through decryption of the encrypted content key by using the volume key, and performs decryption of the encrypted content by using the acquired content key.

Further, in an information processing apparatus according to an embodiment of the present invention, the second recording medium stores encrypted content, and an encrypted content key that is encrypted data of a content key used for decryption of the encrypted content, the first recording medium stores a card key used for decryption of a plurality of encrypted content keys including the encrypted content key, and the decryption section acquires the content key through decryption of the encrypted content key by using the card key, and performs decryption of the encrypted content by using the acquired content key.

According to an embodiment of the present invention, there is provided a data recording system including a recording-data generating section that generates data to be recorded onto a disc, a management server that executes mutual authentication with an IC card or a USB token, and a recording device that performs recording of data onto the disc and the IC card or the USB token, in which the management server executes authentication with the IC card or the USB token inserted in the recording device, and on a condition that the authentication is established, the management server provides the recording device with data used for decryption of encrypted data to be recorded onto the disc, and the recording device records the data provided by the management server onto the IC card or the USB token, on a condition that the authentication is established.

Further, in a data recording system according to an embodiment of the present invention, on a condition that the authentication is established, the management server provides the recording device with a content key used for decryption of encrypted content recorded onto the disc, as data to be recorded onto the IC card or the USB token.

Further, in a data recording system according to an embodiment of the present invention, on a condition that the authentication is established, the management server provides the recording device with identification information of encrypted content recorded onto the disc, as data to be recorded onto the IC card or the USB token.

Further, in a data recording system according to an embodiment of the present invention, on a condition that the authentication is established, the management server provides the recording device with flag data for controlling use of encrypted content recorded onto the disc, as data to be recorded onto the IC card or the USB token.

Further, in a data recording system according to an embodiment of the present invention, on a condition that the authentication is established, the management server acquires a card key stored on the IC card or the USB token, uses the card key to execute encryption of an encryption key used for decryption of encrypted content recorded onto the disc, and provides the recording device with the encrypted encryption key as data to be recorded onto the disc.

Further, according to an embodiment of the present invention, there is provided an information processing method executed by an information processing apparatus, including the steps of an authentication section executing authentication with a first recording medium, and a decryption section executing decryption of encrypted data stored on a second recording medium, in which the executing of decryption includes acquiring data stored on the first recording medium on a condition that authentication with the first recording medium is established, and performing decryption of encrypted data recorded on the second recording medium by using the acquired data.

Further, according to an embodiment of the present invention, there is provided a program for causing an information processing apparatus to execute information processing including the steps of an authentication section executing authentication with a first recording medium, and a decryption section executing decryption of encrypted data stored on a second recording medium, in which the executing of decryption includes acquiring data stored on the first recording medium on a condition that authentication with the first recording medium is established, and performing decryption of encrypted data recorded on the second recording medium by using the acquired data.

It should be noted that the program according to an embodiment of the present invention is a program that can be provided to an image processing apparatus or a computer system which is capable of executing a variety of program codes, via a storage medium or communication medium that is provided in a computer-readable format. By providing such a program in a computer-readable format, processes corresponding to the program are realized on the image processing apparatus or the computer system.

Other objects, features, and advantages of the present invention will become apparent from the following detailed description of embodiments of the present invention and the accompanying drawings. It should be noted that the term system as used in this specification refers to a logical collection of a plurality of devices, and is not limited to one in which devices of respective configurations are located within the same housing.

### BRIEF DESCRIPTION OF THE DRAWINGS

FIG. 1 is a diagram illustrating exemplary manufacture and playback of a content-storing disc;

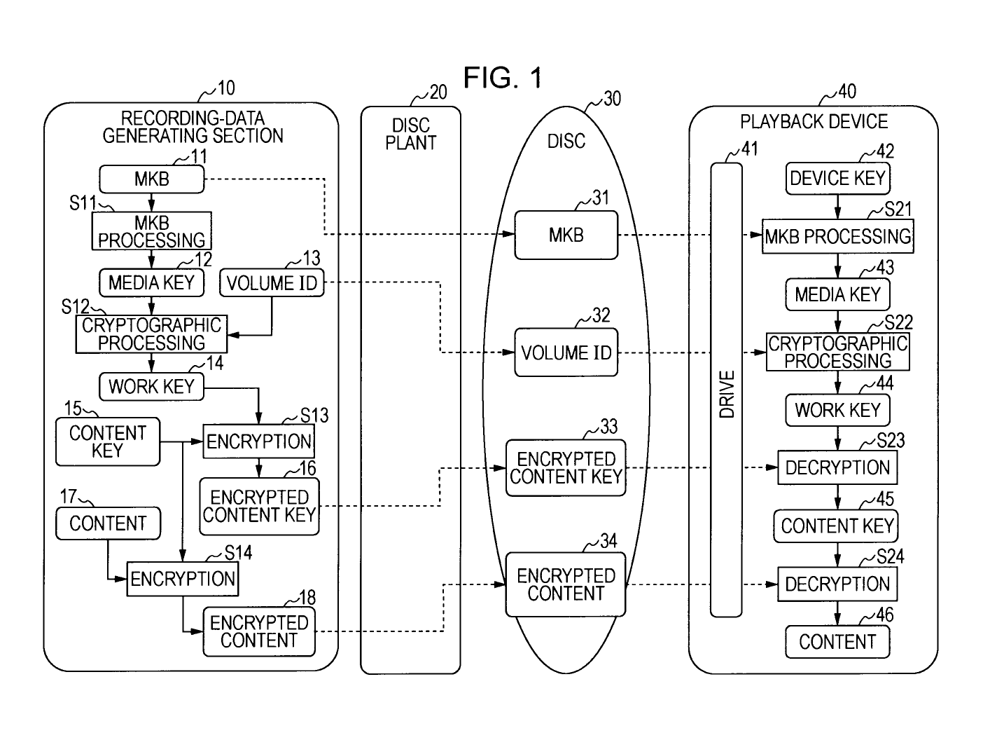

FIG. 2 is a diagram illustrating exemplary disc and IC card applied to content use according to an embodiment of the present invention;

FIG. 3 is a diagram illustrating exemplary functions and stored data for executing mutual authentication in each of an IC card, a management server, and a playback device;

FIG. 4 is a diagram illustrating a configuration and processing according to an embodiment in which a content key is recorded onto an IC card;

FIGS. 5A and 5B are diagrams showing flowcharts respectively illustrating sequences of content recording and playback according to an embodiment in which a content key is recorded onto an IC card;

FIG. 6 is a diagram illustrating a configuration and processing according to an embodiment in which a content key and content information (content ID) are recorded onto an IC card;

FIG. 7 is a diagram showing a flowchart illustrating a sequence of content recording according to an embodiment in which a content key and content information (content ID) are recorded onto an IC card;

FIG. 8 is a diagram showing a flowchart illustrating a sequence of content playback according to an embodiment in which a content key and content information (content ID) are recorded onto an IC card;

FIG. 9 is a diagram illustrating a configuration and processing according to an embodiment in which a content key and content information (content ID and content usage status flag) are recorded onto an IC card;

FIG. 10 is a diagram showing a flowchart illustrating a sequence of content recording according to an embodiment in which a content key and content information (content ID and content usage status flag) are recorded onto an IC card;

FIG. 11 is a diagram showing a flowchart illustrating a sequence of content playback according to an embodiment in which a content key and content information (content ID and content usage status flag) are recorded onto an IC card;

FIG. 12 is a diagram illustrating a configuration and processing according to an embodiment in which a volume key is recorded onto an IC card;

FIG. 13 is a diagram illustrating a configuration and processing according to an embodiment in which a volume key and volume information are recorded onto an IC card;

FIG. 14 is a diagram illustrating a configuration and processing according to an embodiment in which a card key recorded on an IC card is used to record an encrypted content key encrypted with the card key onto a disc;

FIG. 15 is a diagram illustrating a configuration and processing according to an embodiment in which a card key and content information are recorded onto an IC card;

FIG. 16 is a diagram illustrating a configuration and processing according to an embodiment in which a card key and a content ID list are recorded onto an IC card, and an encrypted content key encrypted with the card key is recorded onto a disc;

FIG. 17 is a diagram illustrating a configuration and processing according to an embodiment in which a card key recorded on an IC card is used to record an encrypted volume key encrypted with the card key onto a disc;

FIG. 18 is a diagram illustrating a configuration and processing according to an embodiment in which a card key and volume information are recorded onto an IC card; and

FIG. 19 is a diagram illustrating a configuration and processing according to an embodiment in which a card key and a content ID list are stored onto an IC card, and an encrypted volume key encrypted with the card key is recorded onto a disc.

### DESCRIPTION OF THE PREFERRED EMBODIMENTS

Hereinbelow, details of an information processing apparatus, a data recording system, an information processing method, and a program according to an embodiment of the present invention will be described with reference to the drawings. The description will be given in the following order of items.

1. Overview of processing according to an embodiment of the present invention

2. Configuration of authentication

3. Embodiment in which a content key is recorded onto an IC card (Embodiment 1)

4. Embodiment in which a content key and content information (content ID) are recorded onto an IC card (Embodiment 2)

5. Embodiment in which a content key and content information (content ID and content usage status flag) are recorded onto an IC card (Embodiment 3)

6. Embodiment in which a volume key is recorded onto an IC card (Embodiment 4)

7. Embodiment in which a volume key and volume information are recorded onto an IC card (Embodiment 5)

8. Embodiment in which a card key recorded on an IC card is used to record an encrypted content key encrypted with the card key onto a disc (Embodiment 6)

9. Embodiment in which a card key and content information are recorded onto an IC card (Embodiment 7)

10. Embodiment in which a card key and a content ID list are recorded onto an IC card, and an encrypted content key encrypted with the card key is recorded onto a disc (Embodiment 8)

11. Embodiment in which a card key recorded on an IC card is used to record an encrypted volume key encrypted with the card key onto a disc (Embodiment 9)

12. Embodiment in which a card key and volume information are recorded onto an IC card (Embodiment 10)

13. Embodiment in which a card key and a content ID list are recorded onto an IC card, and an encrypted volume key encrypted with the card key is recorded onto a disc (Embodiment 11)

### [1. Overview of Processing According to an Embodiment of the Present Invention]

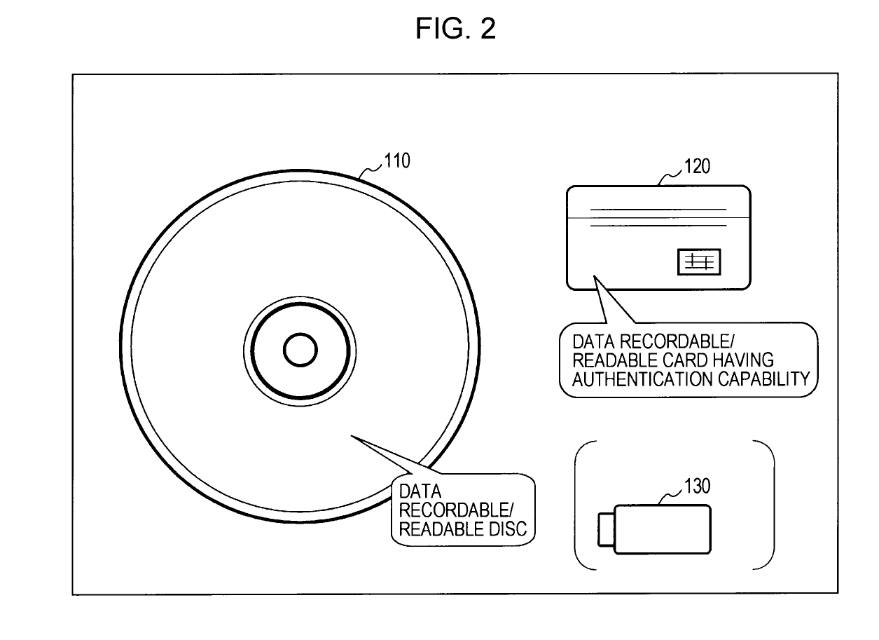

First, an overview of processing according to an embodiment of the present invention will be described. As shown in FIG. 2, in recording and playback of content according to an embodiment of the present invention, a disc 110 for recording content, and an IC card 120 are used. The disc 110 is, for example, an R-type or RE-type data-recordable disc. The disc 110 is set in a recording device to record arbitrary content selected by the user. Content recording can be executed by using, for example, a terminal installed in a public space or the like, or a user's terminal such as a PC owned by the user. It should be noted that a USB token 130 may be used instead of the IC card 120. The USB token 130 stores data necessary for authentication, and can be connected to USB terminals having authentication capability. While the following description will be directed to an example of processing using the IC card 120, the IC card described in the following embodiments can be replaced by a USB token.

When recording content onto the disc 110, the user uses the IC card 120 owned by the user. The IC card 120 has a capability of executing authentication, and allows data recording and data reading.

Prior to recording content onto the disc 110, the user executes communication with a management server via the recording device by using the IC card 120, and executes mutual authentication. Further, data necessary for use (e.g., playback) of content recorded on the disc 120, for example, key data, is written onto the IC card 120.

The user uses (e.g., plays back) content recorded on the disc 120 by using a playback device. The playback device has an authentication section that executes authentication, and a decryption section that executes decryption of encrypted data. To use (e.g., play back) content recorded on the disc 120, first, authentication is performed between the IC card 120 and the playback device. After authentication is established, the playback device reads data recorded on the IC card 120, and executes processing using the read data to use the content recorded on the disc 110.

### [2. Configuration of Authentication]

As previously described, when recording content onto the disc 110, mutual authentication is performed between the IC card 120 and the management server.

Also, when playing back content from the disc 110, mutual authentication is performed between the IC card 120 and the playback device.

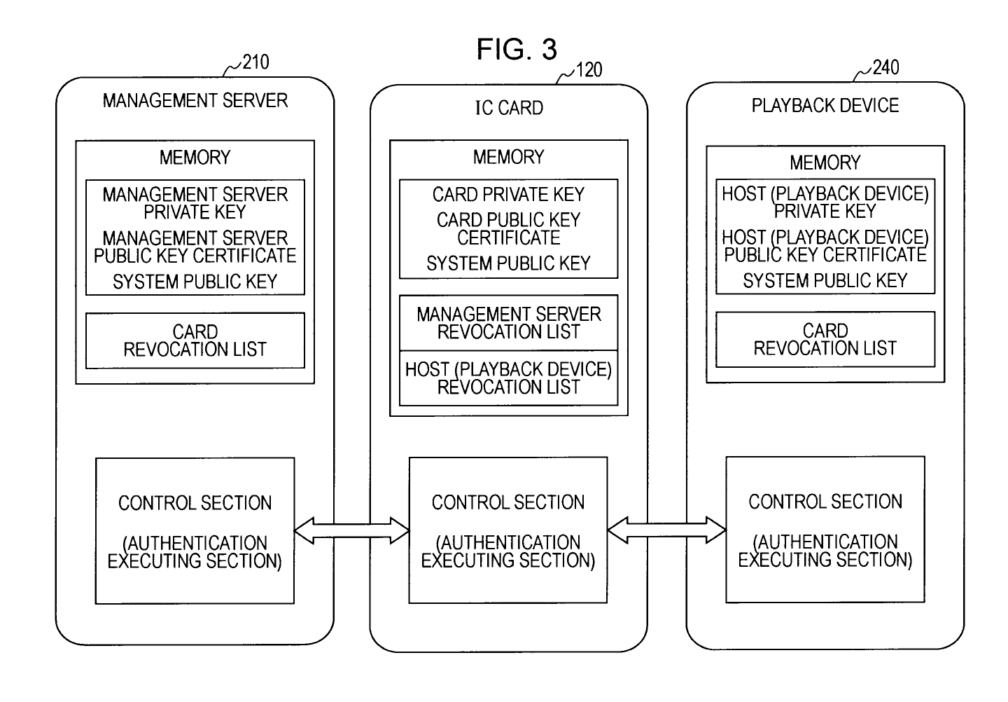

Each of the IC card 120, the management server, and the playback device holds, in a memory, data for performing mutual authentication and a program for executing mutual authentication, and performs mutual authentication through processing by a control section (e.g., CPU) serving as a program executing section. FIG. 3 shows exemplary functions and stored data for executing mutual authentication in each of the IC card 120, a management server 210, and a playback device 240.

It should be noted that this embodiment is directed to the case of executing authentication according to the public key cryptography scheme. This embodiment may be applied to the common key scheme or other schemes, in which case data corresponding to each scheme is stored, and an authentication executing program corresponding to that scheme is executed.

As shown in FIG. 3, the IC card 120 that executes authentication according to the public-key cryptography scheme stores in its memory a card-specific private key and a card-specific public key certificate, and a system public key for the system administrator who executes management of public and private keys, as key data used for mutual authentication. A public key, ID information, and the like are stored in the public key certificate. In addition, a signature with the system private key is set in the public key certificate, thus allowing for tampering verification. To use the ID and public key stored in the public key certificate, first, signature verification is performed using the system private key to confirm that the public key certificate has not been tampered with. After this confirmation, the ID and the public key are extracted for use from the public key certificate.

Further, the IC card 120 has the following revocation lists in its memory:

a management server revocation list; and

a host (playback device) revocation list.

The management server revocation list is a list registering the IDs of revoked management servers. The host (playback device) revocation list is a list registering the IDs of revoked hosts (playback devices). These revocation lists are updated sequentially by the system administrator, and the updated lists are provided via a network, for example. Alternatively, a method may be employed in which the latest revocation lists are recorded on a disc, and the lists are read from the disc by the player to use the latest lists.

Mutual authentication is executed by a control section configured by a CPU or the like having a program execution capability. A mutual-authentication executing program is executed by the control section. Although not shown, this program is stored in a memory. To perform mutual authentication, first, an ID is extracted from a public key certificate acquired from the other party of the mutual authentication, and it is checked whether or not the ID is registered in a revocation list. If the ID extracted from the other authenticating party is registered in the revocation list, it is determined that the party has been revoked, and mutual authentication is not established. In this case, the subsequent processing is cancelled. The subsequent processing includes a mutual authentication sequence according to the public-key cryptography scheme, and further, recording or playback of content planned to be executed after authentication is established.

When recording content onto the disc 110, mutual authentication is performed between the IC card 120 and the management server 210. The management server 210 stores in its memory a management server private key, a management server public key certificate, and a system public key, and performs mutual authentication according to the public-key cryptography scheme in the control section. The management server 210 further holds a card revocation list in the memory. The card revocation list is a list registering the IDs of revoked IC cards.

When performing mutual authentication with the IC card 120, first, an ID is extracted from a public key certificate acquired from the IC card. Further, it is checked whether or not the ID is registered in the revocation list. If the ID extracted from the public key certificate is registered in the revocation list, it is determined that the IC card has been revoked, and mutual authentication is not established. In this case, the subsequent processing is cancelled. The subsequent processing includes a mutual authentication sequence according to the public-key cryptography scheme, and further, recording or playback of content planned to be executed after authentication is established. Processing such as recording of content onto the disc 110 is started only when the mutual authentication is established.

When playing back content from the disc 110, mutual authentication is performed between the IC card 120 and the playback device 240. The playback device 240 stores in its memory a host (playback device) private key, a host (playback device) public key certificate, and a system public key, and performs mutual authentication according to the public-key cryptography scheme in the control section. The playback device 240 further holds a card revocation list in the memory. The card revocation list is a list registering the IDs of revoked IC cards.

When performing mutual authentication with the IC card 120, in the same manner as the above-mentioned process, first, it is checked whether or not the ID of the IC card in the public key certificate is registered in the revocation list. If the ID is registered in the revocation list, it is determined that the IC card has been revoked, and mutual authentication is not established. In this case, the subsequent processing is cancelled. The subsequent processing includes a mutual authentication sequence according to the public-key cryptography scheme, and further, recording or playback of content planned to be executed after authentication is established. Processing such as playback of content from the disc 110 is started only when the mutual authentication is established.

In this way, when recording content onto the disc 110, mutual authentication is performed between the IC card 120 and the management server. When playing back content from the disc 110, mutual authentication is performed between the IC card 120 and the playback device. Hereinbelow, a plurality of embodiments of specific exemplary content recording and playback will be described in order.

[3. Embodiment in which a Content Key is Recorded onto an IC Card (Embodiment 1)]

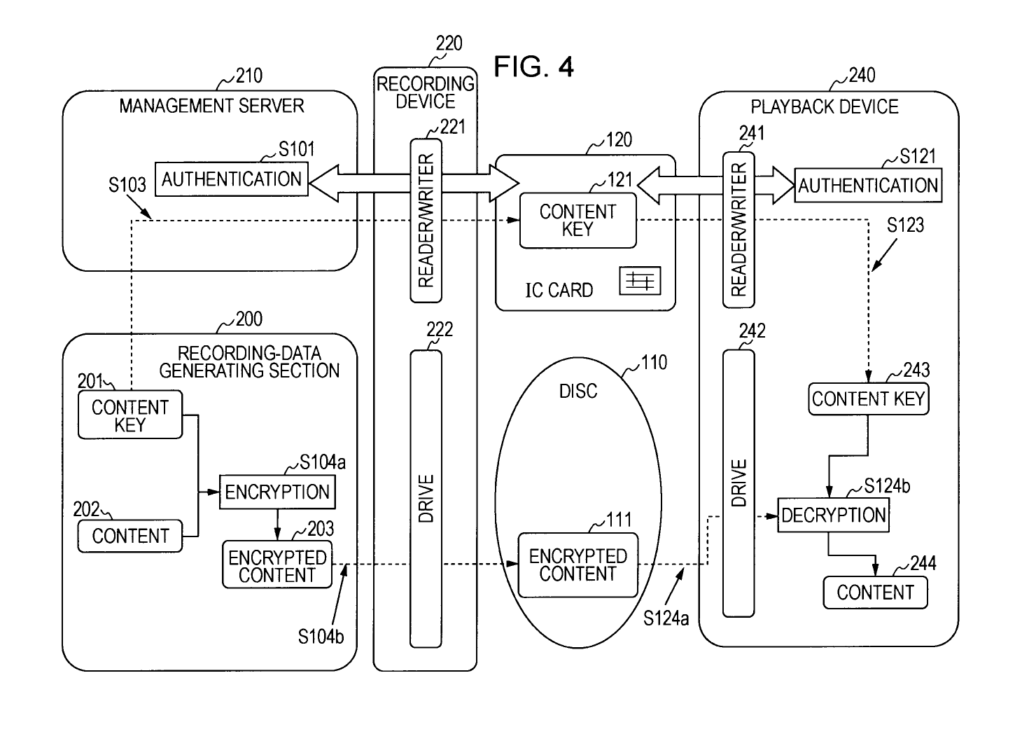

Referring to FIG. 4, a description will be given of an embodiment in which, when recording content onto the disc 110, a content key used for decryption of disc-recorded content is recorded onto the IC card 120, and when playing back content from the disc 110, the content key recorded on the IC card 120 is used.

FIG. 4 shows the following components:

the disc 110 used for recording and playback of content;

the IC card 120 used in recording content onto the disc 110, and in playing back content from the disc 110;

the management server 210 that performs content usage management;

the recording-data generating section 200 that generates data to be recorded onto the disc 110 and the IC card 120;

a recording device (recorder) 220 that performs recording of data onto the disc 110 and the IC card 120; and

the playback device (player) 240 that performs reading of data from the disc 110 and the IC card 120 to play back content stored on the disc 110.

The disc 110 and the IC card 120 are a disc and a card owned by the user. The playback device 240 is, for example, a user's playback device such as a PC or a player.

The recording device 220 is, for example, a device such as a terminal installed in a public place, or a user-owned PC. The recording-data generating section 200, the management server 210, and the recording device 220 are configured so as to be capable of communicating with each other via a network.

The recording device 220 further includes a drive 222 for performing recording of data onto the disc 110, and a reader/writer 221 that performs communication with the IC card 120 and writing and reading of data.

The playback device 240 also includes a drive 242 for performing reading of data from the disc 110, and a reader/writer 241 that performs communication with the IC card 120 and writing and reading of data. In addition, the playback device 240 has an authentication section that executes authentication, and a decryption section that executes decryption of encrypted data.

It should be noted that each of the recording-data generating section 200, the management server 210, the recording device 220, the playback device 240, and further the IC card 120 has a control section that executes various kinds of data processing that will be described with reference to embodiments described later. The control section is configured to include a CPU having a program execution capability, for example. In addition, each of these devices include a memory that stores a program executed in the control section, data, parameters, and the like, and further a communication section that communicates with other devices.

The user holds the disc 110 and the IC card 120, and records content onto the disc 110. The IC card 120 is a card provided to the user in advance. User information is recorded on the memory inside the IC card 120.

As previously mentioned, when recording content onto the disc 110, mutual authentication is performed between the IC card 120 and the management server 210.

When playing back content from the disc 110, mutual authentication is performed between the IC card 120 and the playback device 240.

As described above with reference to FIG. 3, each of the IC card 120, the management server 210, and the playback device 240 holds, in its memory, data for performing mutual authentication, and a program for executing mutual authentication, and performs mutual authentication by processing in the control section (e.g., CPU) serving as a program executing section.

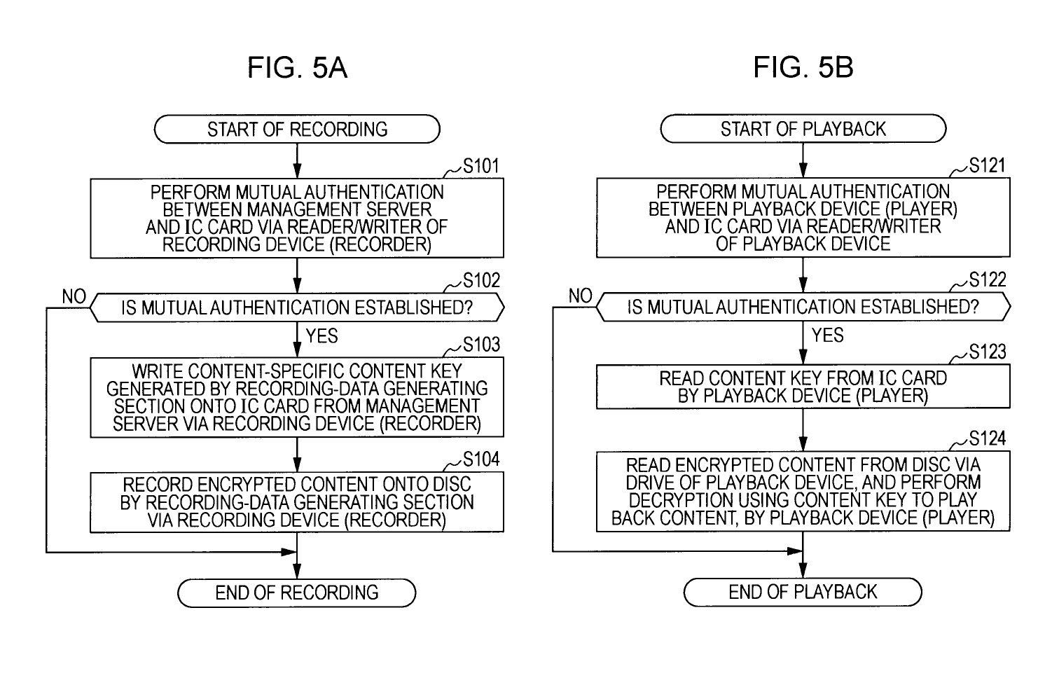

Referring to FIG. 4 and the flowchart in FIG. 5A, a sequence of content recording onto the disc 110 will be described.

When recording content onto the disc 110, the user inserts the disc 110 in the drive 222 of the recording device 220, and sets the IC card 120 in the reader/writer 221 of the recording device 220.

In step S101 shown in FIG. 5A, mutual authentication between the IC card 120 and the management server 210 is executed. As shown in FIG. 4, the mutual authentication in step S101 is performed via the recording device 220. If this mutual authentication is not established, the subsequent processing is cancelled. This corresponds to the case when the result of determination in step S102 of the flow in FIG. 5A is “No”.

If mutual authentication is established and it is determined that both parties can trust each other, the result of determination in step S102 of the flow in FIG. 5A becomes “Yes”, and the processing proceeds to step S103. In step S103, a content-specific content key generated by the recording-data generating section 200 is written onto the IC card 120 from the management server 210 via the reader/writer 221 of the recording device (recorder) 220.

This process is the process indicated by the line representing step S103 shown in FIG. 4. As shown in FIG. 4, a content key 201 generated by the recording-data generating section 200 is transmitted to the recording device 220 from the management server 210, and recorded onto the IC card 120 via the reader/writer 221. Obtained as a result of this recording is a content key 121 shown in FIG. 4. The content key 121 represents key data used for decryption of encrypted content 111 recorded on the disc 110.

Next, in step S104, as shown in the flow in FIG. 5A, the recording-data generating section 200 records encrypted content onto the disc 110 via the recording device 220 (recorder). This process will be described below with reference to FIG. 4.

In FIG. 4, this process in step S104 is indicated as two processes, steps S104a and S104b. First, in step S104a, the recording-data generating section 200 performs encryption using the content key 201 on content 202, generating encrypted content 203.

Next, in step S104b, the recording-data generating section 200 provides the encrypted content 203 to the recording device 220, and the recording device 220 records the encrypted content onto the disc 110 via the drive 222. Obtained as a result of this recording is the encrypted content 111 shown inside the disc 110 in FIG. 4.

In this way, in this embodiment, when recording encrypted content onto the disc, a content key used for decryption of the encrypted content is recorded onto the IC card. It should be noted, however, that recording of data onto the IC card is allowed on the condition that mutual authentication is established between the management server and the IC card.

It is not necessary for the recording-data generating section 200 to encrypt content with a content key to generate encrypted content every time such a request is made from the user. Such content key and encrypted content may be reused, or may be prepared in advance.

Next, referring to FIG. 4 and the flowchart in FIG. 5B, a description will be given of a sequence in the case of using content recorded on the disc 110. While the use of content recorded on the disc 110 refers to such processing as playback of content, and output of content to another device or medium, in the following description, content use is assumed to be content playback.

When playing pack content recorded on the disc 110, the user inserts the disc 110 in the drive 242 of the playback device 240, and sets the IC card 120 in the reader/writer 241 of the playback device 240.

In step S121 shown in FIG. 5B, mutual authentication between the IC card 120 and the playback device 240 is executed. This corresponds to the process in step S121 shown in FIG. 4. If this mutual authentication is not established, the subsequent processing is cancelled. This corresponds to the case when the result of determination in step S122 of the flow in FIG. 5B is “No”.

If mutual authentication is established and it is determined that both parties can trust each other, the result of determination in step S122 of the flow in FIG. 5B becomes “Yes”, and the processing proceeds to step S123. In step S123, the playback device 240 reads the content key recorded on the IC card 120 via the reader/writer 241. This corresponds to the process indicated by the line representing step S123 shown in FIG. 4. As shown in FIG. 4, through this process, the playback device 240 acquires a content key 243.

Next, in step S124 of the flow in FIG. 5B, the playback device 240 reads encrypted content from the disc via the drive of the playback device, and performs decryption with the content key to play back the content.

This process will be described below with reference to FIG. 4. In FIG. 4, this process is indicated as two processes, steps S124a and S124b. First, in step S124a, the playback device 240 reads the encrypted content 111 recorded on the disc 110 via the drive 242. Next, in step S124b, the playback device 240 executes decryption using the content key 243 acquired from the IC card 120, on the encrypted content read from the disc 110, thereby acquiring and playing back content 244.

In this way, in this embodiment, when recording content, the content key used to decrypt encrypted content is recorded onto the IC card on the condition that mutual authentication is established between the IC card and the management server. When playing back content, mutual authentication is performed between the playback device and the IC card, and the content key recorded on the IC card is provided to the playback device on the condition that the mutual authentication is established. The playback device performs decryption of the encrypted content recorded on the disc, by using the content key read from the IC card.

That is, both when recording and playing back content onto and from the disc, the IC card is necessary, and further, confirmation of the credibility of the IC card, that is, establishment of mutual authentication is necessary. Owing to this process, as for the disc itself, a general data-writable disc can be used, and strict content usage control can be performed without writing of a special ID such as one described above with reference to the related art.

[4. Embodiment in which a Content Key and Content Information (Content ID) are Recorded onto an IC Card (Embodiment 2)]

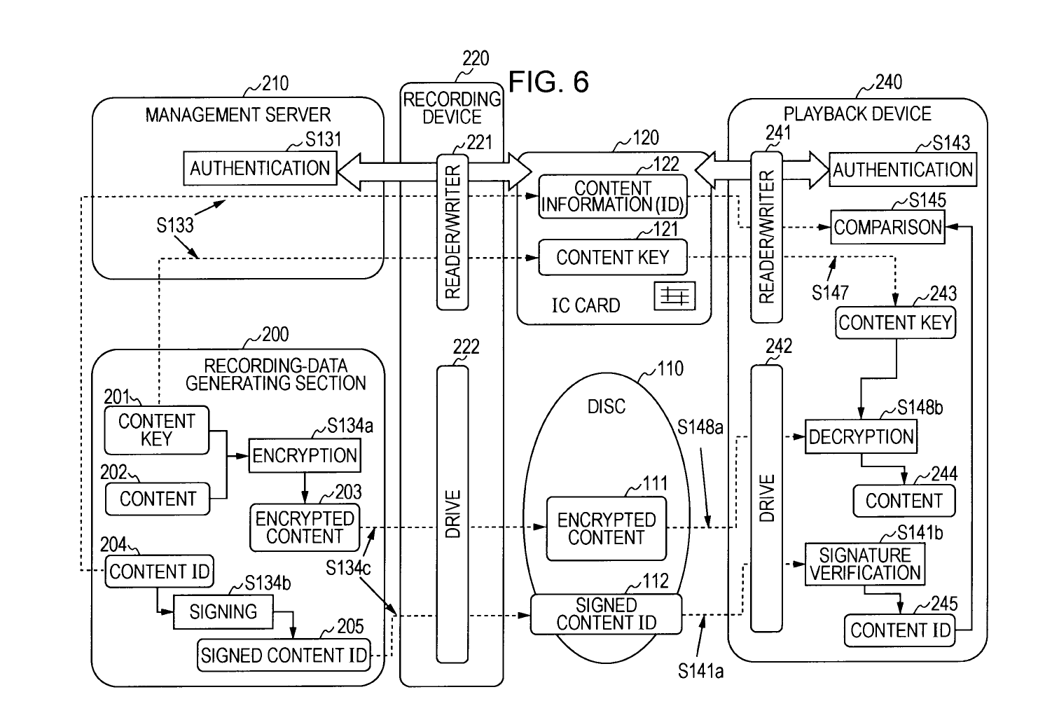

Next, referring to FIGS. 6 to 8, a description will be given of an embodiment in which, when recording content onto the disc 110, a content key used for decryption of disc-recorded content and content information (content ID) are recorded onto the IC card 120, and when playing back content from the disc 110, these pieces of data recorded on the IC card 120 are used.

As in FIG. 4, FIG. 6 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

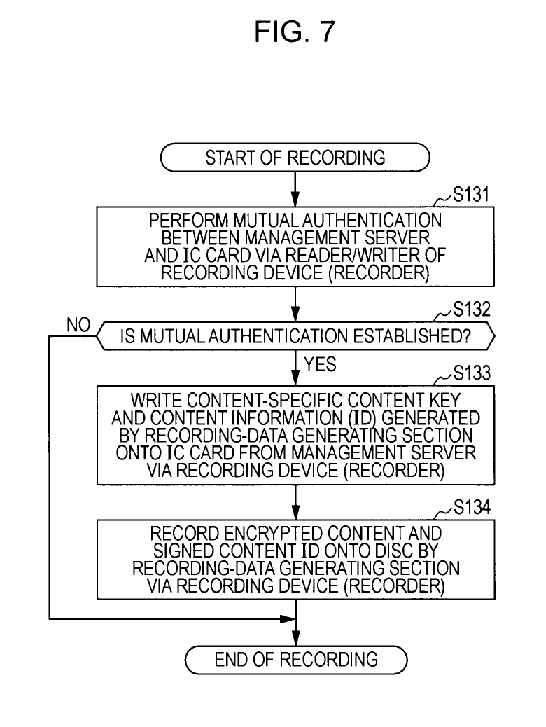

Referring to FIG. 6 and the flowchart in FIG. 7, a sequence of content recording onto the disc 110 will be described.

When recording content onto the disc 110, the user inserts the disc 110 in the drive 222 of the recording device 220, and sets the IC card 120 in the reader/writer 221 of the recording device 220.

In step S131 shown in FIG. 7, mutual authentication between the IC card 120 and the management server 210 is executed. As shown in FIG. 6, the mutual authentication in step S131 is performed via the recording device 220. If this mutual authentication is not established, the subsequent processing is cancelled. This corresponds to the case when the result of determination in step S132 of the flow in FIG. 7 is “No”.

If mutual authentication is established and it is determined that both parties can trust each other, the result of determination in step S132 of the flow in FIG. 7 becomes “Yes”, and the processing proceeds to step S133. In step S133, a content-specific content key and content information generated by the recording-data generating section 200 are written onto the IC card 120 from the management server 210 via the reader/writer 221 of the recording device (recorder) 220. The content information contains a content ID serving as an identifier of the content to be recorded.

This process is the process indicated by the line representing step S133 shown in FIG. 6. As shown in FIG. 6, the content key 201 and a content ID 204 generated by the recording-data generating section 200 are transmitted to the recording device 220 from the management server 210, and recorded onto the IC card 120 via the reader/writer 221. Obtained as a result of this recording are the content key 121 and content information (ID) 122 shown in FIG. 6. The content key 121 represents key data used for decryption of the encrypted content 111 recorded on the disc 110. The content information (ID) 122 is identification information of the encrypted content 111 recorded on the disc 110.

Next, in step S134, as shown in the flow in FIG. 7, the recording-data generating section 200 records encrypted content and a signed content ID onto the disc 110 via the recording device 220 (recorder). This process will be described below with reference to FIG. 6.

In FIG. 6, this process in step S134 is indicated as three processes, steps S134a, S134b, and S134c. First, in step S134a, the recording-data generating section 200 performs encryption using the content key 201 on the content 202, generating the encrypted content 203.

Next, in step S134b, the recording-data generating section 200 executes signing with respect to a content ID serving as an identifier of the content to be recorded onto the disc, thereby generating a signed content ID 205. It should be noted that the signing refers to a process of generating data for executing verification of tempering of a content ID and attaching the data to the content ID.

Next, in step S134c, the recording-data generating section 200 provides the encrypted content 203 and the signed content ID 205 to the recording device 220, and the recording device 220 records these pieces of data onto the disc 110 via the drive 222. Obtained as a result of this recording are the encrypted content 111 and a signed content ID 112 shown inside the disc 110 in FIG. 6.

In this way, in this embodiment, when recording encrypted content onto the disc, a content key used for decryption of the encrypted content and content information (content ID) are recorded onto the IC card. It should be noted, however, that recording of data onto the IC card is allowed on the condition that mutual authentication is established between the management server and the IC card.

It is not necessary for the recording-data generating section 200 to encrypt content with a content key to generate encrypted content, and perform signing of a content ID to generate a signed content ID every time such a request is made from the user. Such content key, encrypted content, content ID, and signed content ID may be reused, or may be prepared in advance.

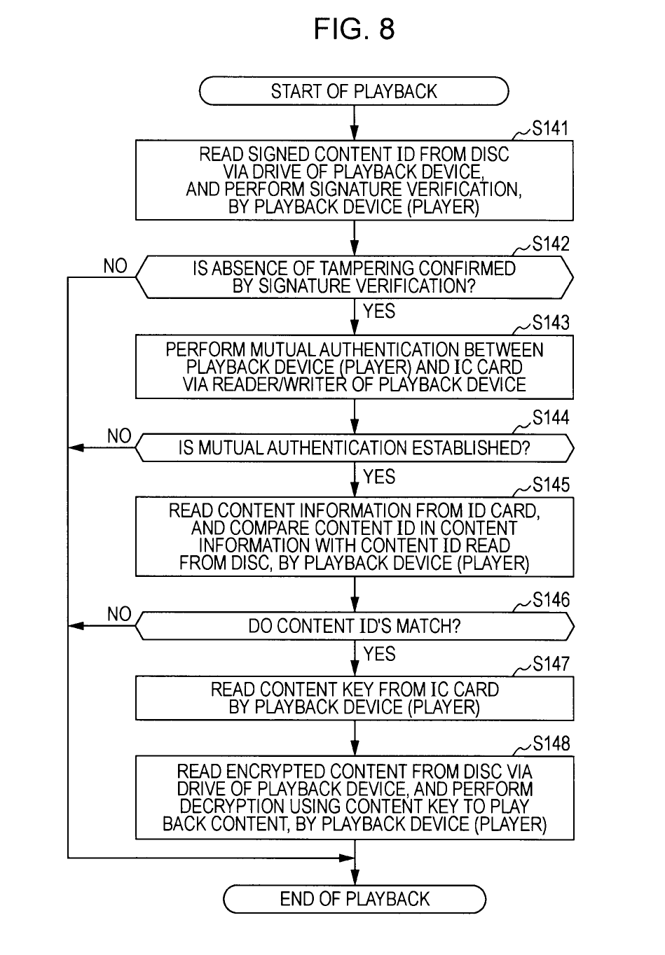

Next, referring to FIG. 6 and the flowchart in FIG. 8, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S141 shown in FIG. 8, the playback device 240 reads the signed content ID 112 from the disc 110 via the drive 242 of the playback device 240, and performs signature verification. This process will be described below with reference to FIG. 6. In FIG. 6, this process is indicated as two processes, steps S141a and S141b. First, in step S141a, the signed content ID 112 is read from the disc 110 via the drive 242. Next, in step S141b, signature verification on the signed content ID 112 is performed. This is a process of confirming whether or not data tempering has been done on the content ID 112. In FIG. 6, a content ID that has been confirmed by the signature verification as being free of tampering is indicated as a content ID 245.

If it is not determined in the signature verification that no tampering has been done, the result of determination in step S142 in the flow shown in FIG. 8 becomes “No”, and the subsequent processing is cancelled. That is, content playback is not executed in this case.

On the other hand, if it is determined in the signature verification that no tampering has been done, the result of determination in step S142 in the flow shown in FIG. 8 becomes “Yes” in this case, and the processing proceeds to step S143. In step S143, mutual authentication between the IC card 120 and the playback device 240 is executed. In correspondence to step S143 shown in FIG. 6, mutual authentication between the IC card 120 and the playback device 240 is performed via the reader/writer 241.

If this mutual authentication is not established, the subsequent processing is cancelled. This corresponds to the case when the result of determination in step S144 of the flow in FIG. 8 is “No”.

If mutual authentication is established and it is determined that both parties can trust each other, the result of determination in step S144 of the flow in FIG. 8 becomes “Yes”, and the processing proceeds to step S145. In step S145, the playback device 240 reads the content information 122 from the IC card 120, and compares the content ID in the content information with the content ID read from the disc 110. This process corresponds to the process in step S145 shown in FIG. 6.

If the two content ID do not match in this comparison, the subsequent processing is cancelled. This corresponds to the case when the result of determination in step S146 of the flow in FIG. 8 is “No”.

If the content IDs match in the ID comparison, the result of determination in step S146 of the flow in FIG. 8 becomes “Yes”, and the processing proceeds to step S147. In step S147, the playback device 240 reads the content key recorded on the IC card 120 via the reader/writer 241. This corresponds to the process indicated by the line representing step S147 shown in FIG. 6. As shown in FIG. 6, through this process, the playback device 240 acquires the content key 243.

Next, in step S148 of the flow in FIG. 8, the playback device 240 reads encrypted content from the disc via the drive of the playback device, and performs decryption with the content key to play back the content.

This process will be described below with reference to FIG. 6. In FIG. 6, this process is indicated as two processes, steps S148a and S148b. First, in step S148a, the playback device 240 reads the encrypted content 111 recorded on the disc 110 via the drive 242. Next, in step S148b, the playback device 240 executes decryption using the content key 243 acquired from the IC card 120, on the encrypted content read from the disc 110, thereby acquiring and playing back the content 244.

In this way, in this embodiment, when recording content, a content key used to decrypt encrypted content and content information (content ID) are recorded onto the IC card on the condition that mutual authentication is established between the IC card and the management server.

When playing back content, mutual authentication is performed between the playback device and the IC card, and the content information (content ID) and the content key recorded on the IC card are provided to the playback device on the condition that the mutual authentication is established.

The playback device verifies the signature of the signed content ID read from the disc, and then compares the signed content ID with the content information (content ID) read from the IC card. After confirming a match, the playback device performs decryption of the encrypted content recorded on the disc by using the content key read from the IC card.

In this embodiment as well, both when recording and playing back content onto and from the disc, the IC card is necessary, and further, confirmation of the credibility of the IC card, that is, establishment of mutual authentication is necessary. Owing to this process, as for the disc itself, a general data-writable disc can be used, and strict content usage control can be performed without writing of a special ID such as one described above with reference to the related art. In addition, more strict content management can be performed by use of the content ID.

[5. Embodiment in which a Content Key and Content Information (Content ID and Content Usage Status Flag) are Recorded onto an IC Card (Embodiment 3)]

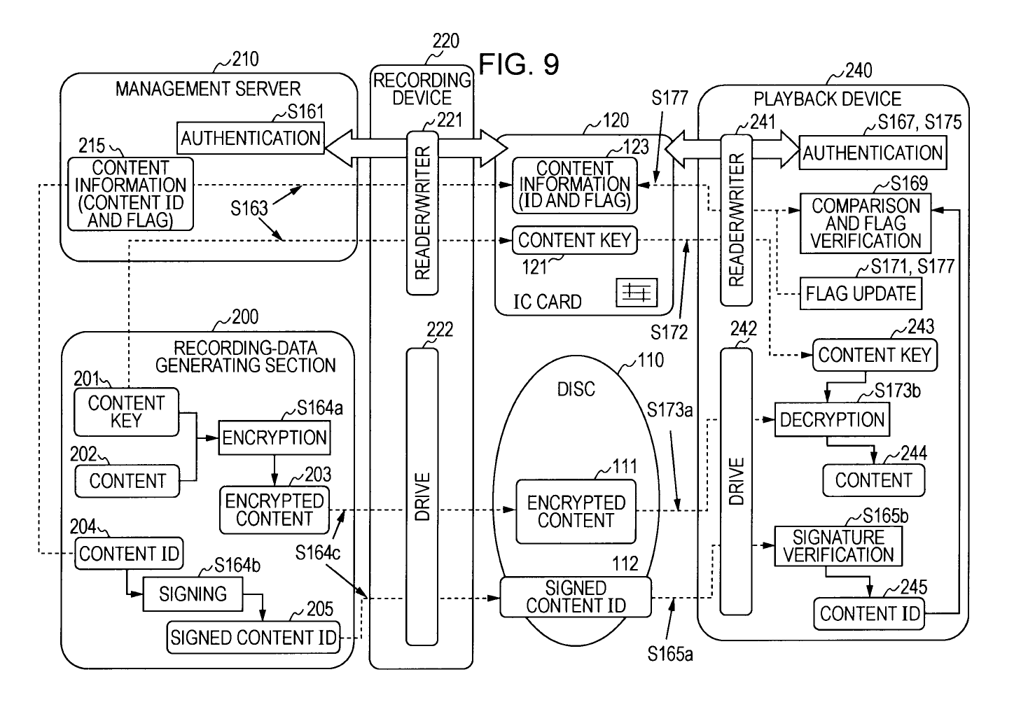

Next, referring to FIGS. 9 to 11, a description will be given of an embodiment in which when recording content onto the disc 110, a content key used for decryption of disc-recorded content and content information (content ID and content usage status flag) are recorded onto the IC card 120, and when playing back content from the disc 110, these pieces of data recorded on the IC card 120 are used.

In the embodiment described above with reference to FIGS. 6 to 8, content information as information to be written onto the IC card contains a content ID. This embodiment differs from the above embodiment in that content information as information to be written onto the IC card contains not only a content ID but also a content usage status flag. The flag indicates the usage status of content recorded on the disc. The use of the disc-recorded content is controlled in accordance with the value of this flag. When recording content onto the disc, the flag is set to a value indicating permission of content use, and recorded onto the IC card.

For the playback device to read and use content recorded on the disc, the playback device performs a process of reading the flag from the IC card, and rewriting the value of the flag to a flag value (invalid value) indicating non-permission of content use. At the time when the playback device finishes content use, the flag in the IC card is rewritten to a flag value (valid value) indicating permission of content use. It should be noted that rewriting of the flag is performed on the condition that mutual authentication is established between the IC card and the playback device.

As in FIGS. 4 and 6, FIG. 9 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

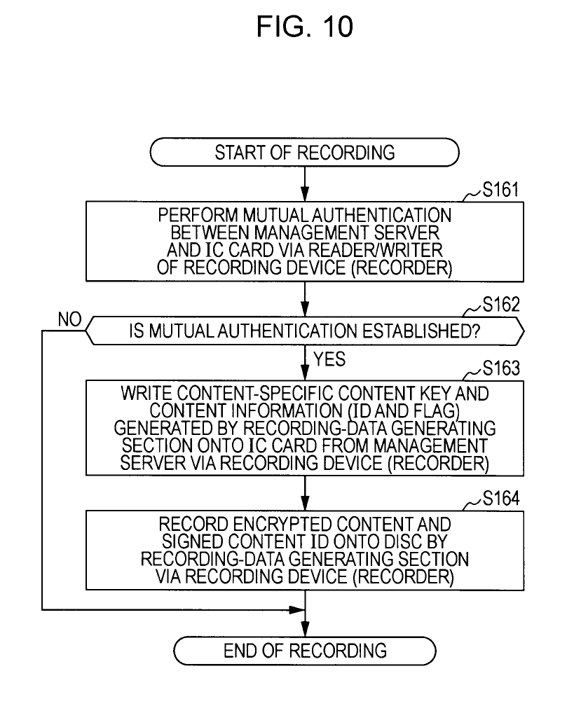

Referring to FIG. 9 and the flowchart in FIG. 10, a sequence of content recording onto the disc 110 will be described.

When recording content onto the disc 110, the user inserts the disc 110 in the drive 222 of the recording device 220, and sets the IC card 120 in the reader/writer 221 of the recording device 220.

In step S161 shown in FIG. 10, mutual authentication between the IC card 120 and the management server 210 is executed. As shown in FIG. 9, the mutual authentication in step S161 is performed via the recording device 220. If this mutual authentication is not established, the subsequent processing is cancelled. This corresponds to the case when the result of determination in step S162 of the flow in FIG. 10 is “No”.

If mutual authentication is established and it is determined that both parties can trust each other, the result of determination in step S162 of the flow in FIG. 10 becomes “Yes”, and the processing proceeds to step S163. In step S163, a content-specific content key and content information are written onto the IC card 120. A content-specific content key and a content ID generated by the recording-data generating section 200 are provided to the management server 210. The management server 210 generates content information by adding a content usage status flag to the content ID, and provides the content information as recording data to the recording device (recorder) 220. The recording device (recorder) 220 executes a process of writing the content key and the content information onto the IC card 120 by using the reader/writer 221. The content information contains the content ID serving as an identifier of the content to be recorded onto the disc 110, and the content usage status flag.

At the time of the writing of content information onto the IC card which is executed when recording content onto the disc, the value of the content usage status flag is set to a valid value. That is, the value of the content usage status flag is set to a flag value indicating permission of use of the disc-recorded content. This process corresponds to the process indicated by the line representing step S163 shown in FIG. 9. As shown in FIG. 9, the content key 201 and the content ID 204 generated by the recording-data generating section 200 are provided to the management server 210. The management server 210 generates content information 215 by adding the content usage status flag to the content ID, and transmits the content information from the management server 210 to the recording device 220. The recording device 220 records the content information onto the IC card 120 via the reader/writer 221. Obtained as a result of this recording are the content key 121 and content information (ID and flag) 123. The content key 121 is key data used for decryption of the encrypted content 111 recorded on the disc 110, and the ID contained in the content information 123 is identification information of the encrypted content 111 recorded on the disc 110. This flag is set to a valid value in the state when use of the encrypted content 111 stored on the disc 110 is permitted, and set to an invalid value in the state when use of the encrypted content 111 stored on the disc 110 is not permitted.

Next, in step S164, as shown in the flow in FIG. 10, the recording-data generating section 200 records the encrypted content, and the signed content ID onto the disc 110 via the recording device 220 (recorder). This process will be described below with reference to FIG. 9.

In FIG. 9, this process in step S164 is indicated as three processes, steps S164a, S164b, and S164c. First, in step S164a, the recording-data generating section 200 performs encryption using the content key 201 on the content 202, generating the encrypted content 203.

Next, in step S164b, the recording-data generating section 200 executes signing with respect to a content ID serving as an identifier of the content to be recorded onto the disc, thereby generating the signed content ID 205. It should be noted that the signing refers to a process of generating data for executing verification of tempering of a content ID and attaching the data to the content ID.

Next, in step S164c, the recording-data generating section 200 provides the encrypted content 203 and the signed content ID 205 to the recording device 220, and the recording device 220 records these pieces of data onto the disc 110 via the drive 222. Obtained as a result of this recording are the encrypted content 111 and the signed content ID 112 shown inside the disc 110 in FIG. 9.

In this way, in this embodiment, when recording encrypted content onto the disc, a content key used for decryption of the encrypted content and content information (content ID and flag) are recorded onto the IC card. It should be noted, however, that recording of data onto the IC card is allowed on the condition that mutual authentication is established between the management server and the IC card.

It is not necessary for the recording-data generating section 200 to encrypt content with a content key to generate encrypted content, and perform signing of a content ID to generate a signed content ID every time such a request is made from the user. Such content key, encrypted content, content ID, and signed content ID may be reused, or may be prepared in advance.

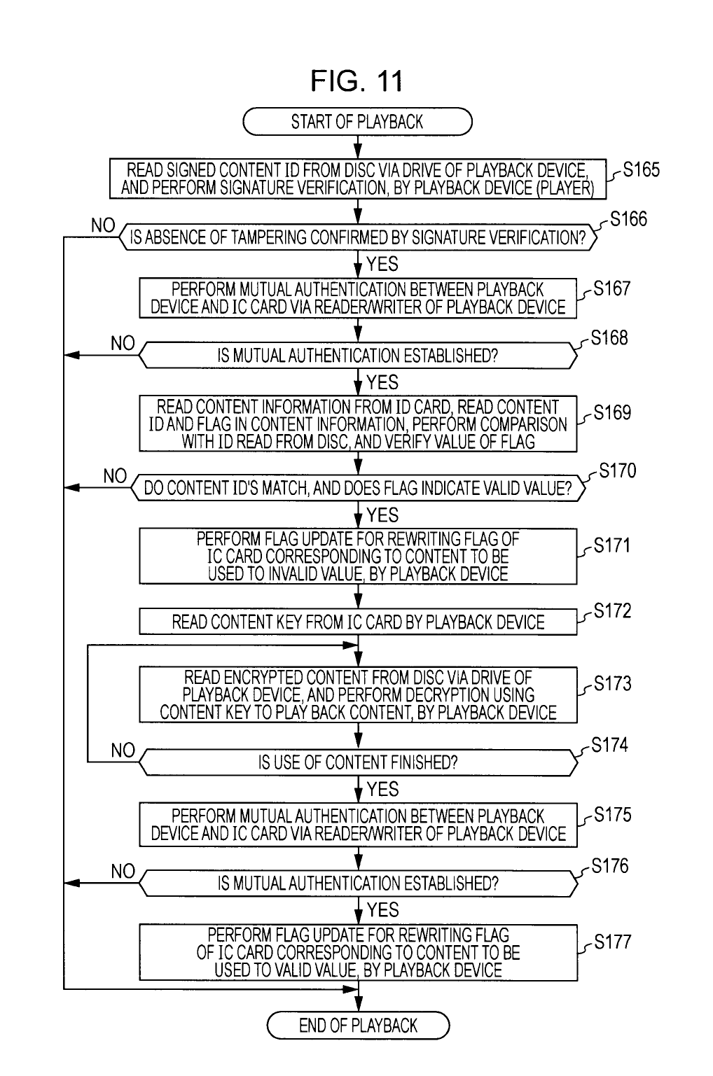

Next, referring to FIG. 9 and the flowchart in FIG. 11, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S165 shown in FIG. 11, the playback device 240 reads the signed content ID 112 from the disc 110 via the drive 242 of the playback device 240, and performs signature verification. This process will be described below with reference to FIG. 9. In FIG. 9, this process is indicated as two processes, steps S165a and S165b. First, in step S165a, the signed content ID 112 is read from the disc 110 via the drive 242. Next, in step S165b, signature verification on the signed content ID 112 is performed. This is a process of confirming whether or not data tempering has been done on the content ID 112. In FIG. 9, a content ID that has been confirmed by the signature verification as being free of tampering is indicated as the content ID 245.

If it is not determined in the signature verification that no tampering has been done, the result of determination in step S166 in the flow shown in FIG. 11 becomes “No”, and the subsequent processing is cancelled. That is, content playback is not executed in this case.

On the other hand, if it is determined in the signature verification that no tampering has been done, the result of determination in step S166 in the flow shown in FIG. 11 becomes “Yes” in this case, and the processing proceeds to step S167. In step S167, mutual authentication between the IC card 120 and the playback device 240 is executed. This process corresponds to step S167 shown in FIG. 9. The mutual authentication between the IC card 120 and the playback device 240 is performed via the reader/writer 241.

If this mutual authentication is not established, the subsequent processing is cancelled. This corresponds to the case when the result of determination in step S168 of the flow in FIG. 11 is “No”.

If mutual authentication is established and it is determined that both parties can trust each other, the result of determination in step S168 of the flow in FIG. 11 becomes “Yes”, and the processing proceeds to step S169. In step S169, the playback device 240 reads the content information (ID and flag) 123 from the IC card 120, and compares the content ID in the content information with the content ID read from the disc 110. Further, the playback device 240 verifies whether or not the value of the content usage status flag contained in the content information is set to a valid value indicating permission of content use. This process corresponds to the process in step S169 shown in FIG. 9.

First, if the two content IDs do not match in the ID comparison, the subsequent processing is cancelled. The subsequent processing is cancelled also if the value of the content usage status flag contained in the content information is not set to a valid value indicating permission of content use. These cases correspond to when the result of determination in step S170 of the flow in FIG. 11 is “No”.

If it is confirmed by the ID comparison that the content IDs match, and the value of the content usage status flag is set to a valid value indicating permission of content use, the result of the determination in step S170 of the flow in FIG. 11 becomes “Yes”, and the processing proceeds to step S171. In step S171, the playback device 240 performs a flag update that changes the value of the flag in content information recorded on the IC card 120. That is, the playback device 240 performs a flag update that sets the flag to an invalid value indicating non-permission of use of disc-recorded content. The playback device 240 changes the value of the flag recorded on the IC card 120, via the reader/writer 241. This process corresponds to the process in step S171 shown in FIG. 9.

Next, in step S172, the playback device 240 reads the content key recorded on the IC card 120 via the reader/writer 241. This corresponds to the process indicated by the line representing step S172 shown in FIG. 9. As shown in FIG. 9, through this process, the playback device 240 acquires the content key 243.

Next, in step S173 of the flow in FIG. 11, the playback device 240 reads encrypted content from the disc via the drive of the playback device, and performs decryption with the content key to play back the content.

This process will be described below with reference to FIG. 9. In FIG. 9, this process is indicated as two processes, steps S173a and S173b. First, in step S173a, the playback device 240 reads the encrypted content 111 recorded on the disc 110 via the drive 242. Next, in step S173b, the playback device 240 executes decryption using the content key 243 acquired from the IC card 120, on the encrypted content read from the disc 110, thereby acquiring and playing back the content 244.

Next, in step S174 of the flow shown in FIG. 11, if the playback device determines that use of content is finished, the processing proceeds to step S175, and mutual authentication between the IC card 120 and the playback device 240 is executed. This process corresponds to the process in step S175 shown in FIG. 9. The mutual authentication between the IC card 120 and the playback device 240 is performed via the reader/writer 241.

If this mutual authentication is not established, the subsequent processing is cancelled. This corresponds to the case when the result of determination in step S176 of the flow in FIG. 11 is “No”.

If mutual authentication is established and it is determined that both parties can trust each other, the result of determination in step S176 of the flow in FIG. 11 becomes “Yes”, and the processing proceeds to step S177. In step S177, the playback device 240 performs a flag update that changes the value of the flag in content information recorded on the IC card 120. That is, the playback device 240 performs a flag update that sets the flag to a valid value indicating permission of use of disc-recorded content. The playback device 240 changes the value of the flag recorded on the IC card 120, via the reader/writer 241. This process corresponds to the process in step S177 shown in FIG. 9.

In this way, in this embodiment, when recording content, a content key used to decrypt encrypted content and content information (content ID) are recorded onto the IC card on the condition that mutual authentication is established between the IC card and the management server.

When playing back content, mutual authentication is performed between the playback device and the IC card, and the content information (content ID) and the content key recorded on the IC card are provided to the playback device on the condition that the mutual authentication is established.

The playback device verifies the signature of the signed content ID read from the disc, and then compares the signed content ID with the content information (content ID) read from the IC card to confirm a match. Further, the playback device performs verification as to whether or not the value of the content usage status flag contained in the content information read from the IC card is set to a valid value indicating permission of content use. If it is confirmed that the IDs match and the flag indicates a valid value, the playback device performs decryption of the encrypted content recorded on the disc by using the content key read from the IC card.

In addition, the flag is set to an invalid value during use of content in the playback device, and at the time when the use of content is finished, the flag is set to a valid value after establishment of authentication with the IC card.

In this embodiment, a setting is made such that in addition to the above-mentioned embodiment described with reference to FIGS. 6 to 8 in which content information including only a content ID is written, a content usage status flag is further written onto the IC card. This flag makes it possible to prevent parallel uses of content on a plurality of playback devices. That is, even in the case when the IC card and the disc are removed from the playback device that is executing content use, and it is attempted to play back disc-stored content, the content usage status flag recorded on the IC card has been set to an invalid value. By use of such a flag, simultaneous uses of a single disc-stored content on a plurality of playback devices are prevented. In this way, in this embodiment, simultaneous uses of content on a plurality of playback devices are prevented, thereby enabling content usage restriction such that use of content is permitted only on a single playback device.

In the above-mentioned processing example, the number of playback devices that can use disc-recorded content simultaneously is set to one. However, by setting the flag as data with a plurality of bits, the number of simultaneous uses of disc-recorded content permitted may be set to plural.

For example, if the number of simultaneous uses of disc-recorded content permitted is set to [3], the flag recorded on the IC card is set to have two bits. That is, flag settings of [00] to [11] are possible.

Suppose that the initial setting of the flag written onto the IC card at the time of recording content onto the disc is [00]. The playback device that performs use of disc-recorded content executes a flag rewrite for incrementing the flag setting by 1. That is, each playback device performs a flag rewrite in accordance with the following settings.

Initial setting=[00]

Use of content on the first playback device=[01]

Use of content on the second playback device=[10]

Use of content on the third playback device=[11]

If the number of playback devices allowed to use content simultaneously is set to [3], the flag value [11] corresponds to an invalid value. In this case, playback of content from the disc is not permitted on the fourth device in which the IC card whose flag value has become [11] is inserted. In this way, by increasing the number of bits of the flag, the number of simultaneous uses of content permitted can be set arbitrarily.

[6. Embodiment in which a Volume Key is Recorded onto an IC Card (Embodiment 4)]

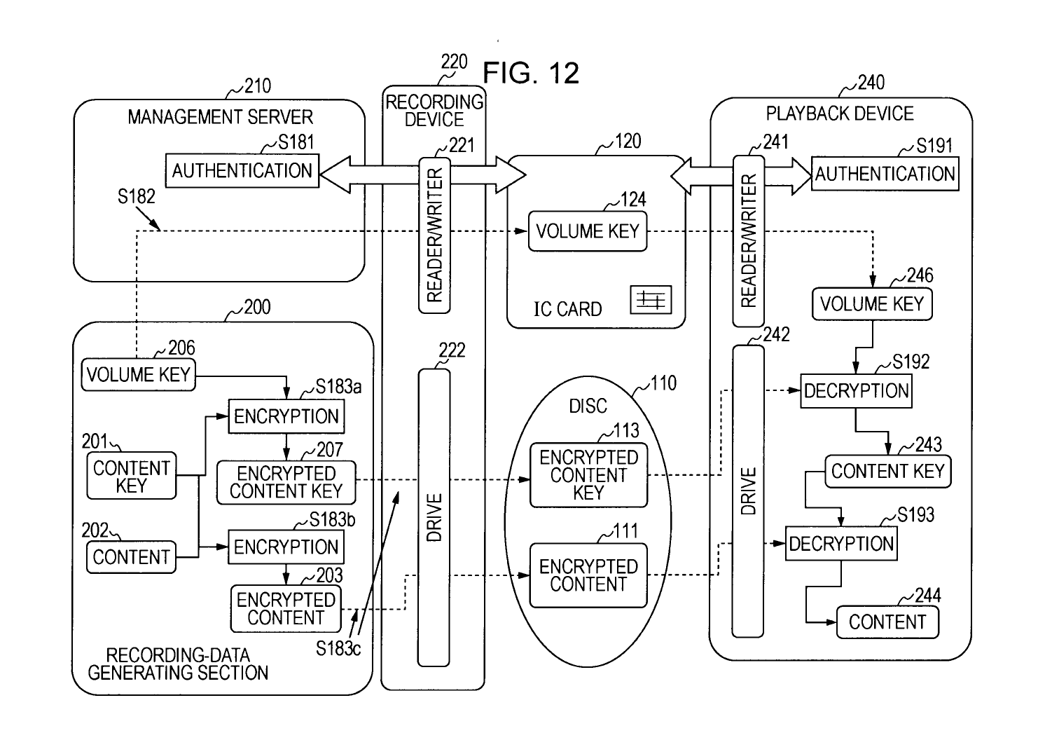

Next, referring to FIG. 12, a description will be given of an embodiment in which when recording content onto the disc 110, a volume key used for decryption of disc-recorded content is recorded onto the IC card 120, and when playing back content from the disc 110, this data recorded on the IC card is used.

As in the above-mentioned embodiments, FIG. 12 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 12, a volume key 124 is recorded on the IC card 120. The volume key 124 is a key used for encryption and decryption of a content key. The content key is recorded on the disc 110 as an encrypted content key 113.

It should be noted that the volume key is set as a key common to a plurality of different contents and content keys. For example, a single volume key is set for a set of 10 different contents. Encryption and decryption of a plurality of content keys are performed by using the single volume key.

Referring to FIG. 12, a description will be given of content recording and content playback according to this embodiment.

First, content recording will be described.

When recording content onto the disc 110, the user inserts the disc 110 in the drive 222 of the recording device 220, and sets the IC card 120 in the reader/writer 221 of the recording device 220.

In step S181 shown in FIG. 12, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S182, a volume key is written onto the IC card 120. A volume key 206 generated by the recording-data generating section 200 is provided to the management server 210, and further, recording data is provided from the management server 210 to the recording device (recorder) 220. The recording device (recorder) 220 executes writing of the volume key onto the IC card 120 by using the reader/writer 221. As shown in FIG. 12, the volume key 124 is stored onto the IC card 120.

Next, recording of data generated by the recording-data generating section onto the disc 110 is executed. This process corresponds to each of steps S183a to S183c shown in FIG. 12. First, in step S183a, encryption is performed on the content key 201 by using the volume key 206, generating an encrypted content key 207. Further, in step S183b, encryption of the content 202 is performed by using the content key 201, generating the encrypted content 203. Next, in step S183c, the encrypted content key 207 and the encrypted content 203 are provided to the recording device 220, and the recording device 220 records these pieces of data onto the disc 110 via the drive 222. Obtained as a result of this recording are the encrypted content 111 and the encrypted content key 113 shown inside the disc 110 in FIG. 12.

It is not necessary for the recording-data generating section 200 to encrypt content with a content key to generate encrypted content, and encrypt the content key with a volume key to generate an encrypted content key every time such a request is made from the user. Such encrypted content, volume key, and encrypted content key may be reused, or may be prepared in advance.

Next, referring to FIG. 12, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S191 shown in FIG. 12, mutual authentication between the IC card 120 and the playback device 240 is executed. The mutual authentication between the IC card 120 and the playback device 240 is performed via the reader/writer 241. If this mutual authentication is not established, the subsequent processing is cancelled.

If mutual authentication is established and it is determined that both parties can trust each other, in step S192, the playback device 240 reads the volume key from the IC card 120, and executes decryption of the encrypted content key 113 acquired from the disc 110. The playback device 240 acquires the content key 243 through decryption using a volume key 246 shown in FIG. 12.

Next, as shown in FIG. 12, in step S193, the playback device 240 reads the encrypted content 111 recorded on the disc 110 via the drive 42, and executes decryption using the content key 243 on the encrypted content, thereby acquiring and playing back the content 244.

[7. Embodiment in which a Volume Key and Volume Information are Recorded onto an IC Card (Embodiment 5)]

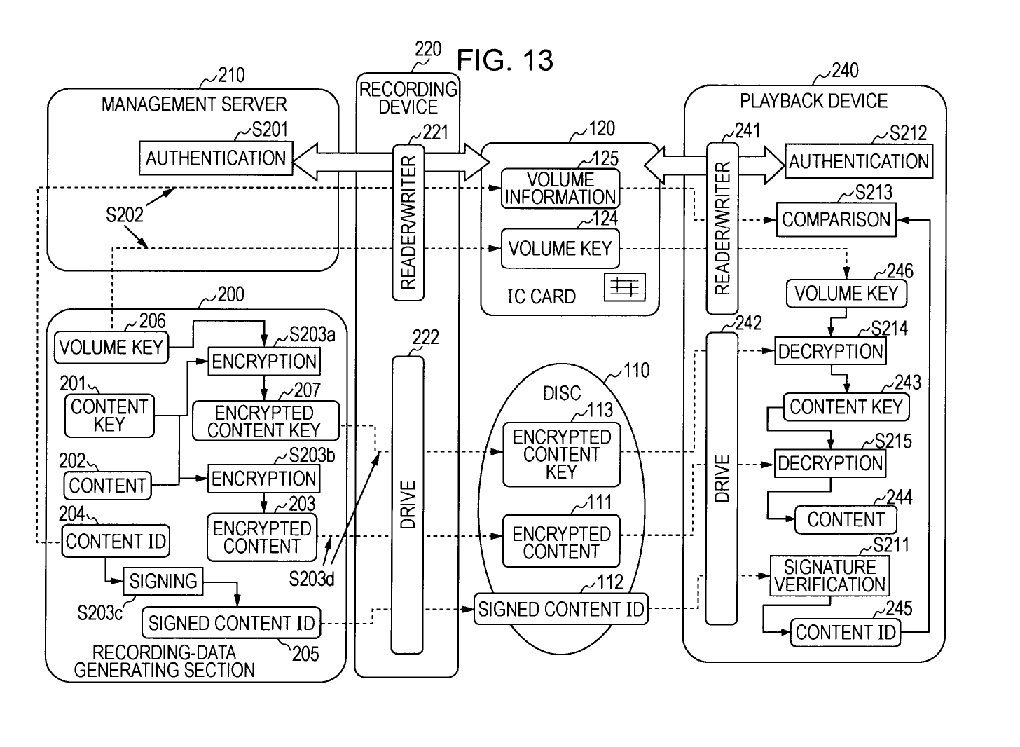

Next, referring to FIG. 13, a description will be given of an embodiment in which when recording content onto the disc 110, a volume key used for encryption of disc-recorded content and volume information are recorded onto the IC card 120, and when playing back content from the disc 110, these pieces of data recorded on the IC card 120 are used.

As in the above-mentioned embodiments, FIG. 13 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 13, in addition to the volume key 124, volume information is also recorded onto the IC card 120. The volume information contains a volume ID, and content usage status flags of individual contents corresponding to each volume.

As previously mentioned, a volume key is set in correspondence to a plurality of contents and content keys. For example, a volume key Kv corresponding to a set of the following is set.

Content A/content key A

Content B/content key B

Content C/content key C

In the case of this setting, the volume information contains content IDs corresponding to the three contents A to C. Alternatively, these three content IDs, and usage status flags corresponding to the three contents A to C are set.

Referring to FIG. 13, content recording and content playback according to this embodiment will be described. It should be noted that in the example shown in FIG. 13, content information contains only a content ID. First, content recording will be described.

When recording content onto the disc 110, the user inserts the disc 110 in the drive 222 of the recording device 220, and sets the IC card 120 in the reader/writer 221 of the recording device 220.

In step S201 shown in FIG. 13, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S202, a volume key and volume information are written onto the IC card 120. The volume key 206 and the content ID 204 generated by the recording-data generating section 200 are provided to the management server 210. Further, the management server 210 provides these pieces of data to the recording device (recorder) 220. The recording device (recorder) 220 executes a process of writing content information including the volume key and the content ID onto the IC card 120 by using the reader/writer 221. As shown in FIG. 13, the volume key 124 and volume information 125 are stored onto the IC card 120.

Next, recording of data generated by the recording-data generating section onto the disc 110 is executed. This process corresponds to each of steps S203a to S203d shown in FIG. 13. First, in step S203a, encryption using the volume key 206 is performed on the content key 201, generating the encrypted content key 207. Further, in step S203b, encryption of the content 202 is performed by using the content key 201, generating the encrypted content 203. Further, in step S203c, generation of a signature is executed with respect to the content ID 204, generating the signed content ID 205.

Next, in step S203d, the encrypted content key 207, the encrypted content 203, and the signed content ID 205 are provided to the recording device 220, and the recording device 220 records these pieces of data onto the disc 110 via the drive 222. Obtained as a result of this recording are the encrypted content 111, the encrypted content key 113, and the signed content ID 112 shown inside the disc 110 in FIG. 13.

It is not necessary for the recording-data generating section 200 to encrypt content with a content key to generate encrypted content, encrypt the content key with a volume key to generate an encrypted content key, and perform signing of a content ID to generate a signed content ID every time such a request is made from the user. Such encrypted content, volume key, encrypted content key, content ID, and signed content ID may be reused, or may be prepared in advance.

Next, referring to FIG. 13, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S211 shown in FIG. 13, the playback device 240 reads the signed content ID 112 from the disc 110 via the drive 242 of the playback device 240, and performs signature verification. This is a process of confirming whether or not data tempering has been done on the content ID 112. In FIG. 13, a content ID that has been confirmed by the signature verification as being free of tampering is indicated as the content ID 245.

If it is not determined in the signature verification that no tampering has been done, the subsequent processing is cancelled. That is, content playback is not executed in this case. On the other hand, if it is determined in the signature verification that no tampering has been done, as indicated by step S212, mutual authentication between the IC card 120 and the playback device 240 is executed in this case. The mutual authentication between the IC card 120 and the playback device 240 is performed via the reader/writer 241. If this mutual authentication is not established, the subsequent processing is cancelled.

If mutual authentication is established and it is determined that both parties can trust each other, the playback device 240 reads the volume information 125 from the IC card 120, and compares content IDs in the volume information with the content ID read from the disc 110. This process corresponds to the process in step S213 shown in FIG. 13. It should be noted that a plurality of content IDs are recorded in the volume information 125 recorded on the IC card 120, and it suffices that one of these plurality of content IDs matches the content ID read from the disc 110.

If the two content IDs do not match in this comparison, the subsequent processing is cancelled. If the content IDs match in the ID comparison, the playback device 240 reads the volume key 124 recorded on the IC card 120 via the reader/writer 241. Obtained as a result of this reading is the volume key 246 shown inside the playback device 240.

Further, in step S214, the playback device 240 reads an encrypted content key from the disc via the drive of the playback device, and performs decryption using the volume key to acquire the content key 243. Next, in step S215, the playback device 240 reads encrypted content from the disc via the drive of the playback device, performs decryption with the content key 243, thereby acquiring the content 244 for content playback.

While the above-mentioned processing example is directed to the case in which only content IDs are stored in the volume information, a setting may be employed which stores usage status flags for individual contents, so that only those contents whose usage status flags indicate a valid value can be used. Under this setting, the playback device executes a process of checking the value of the flag of content corresponding to the disc-stored content to be used, and performs decryption and playback only when the flag is set to a valid value.

[8. Embodiment in which a Card Key Recorded on an IC Card is Used to Record an Encrypted Content Key Encrypted with the Card Key onto a Disc (Embodiment 6)]

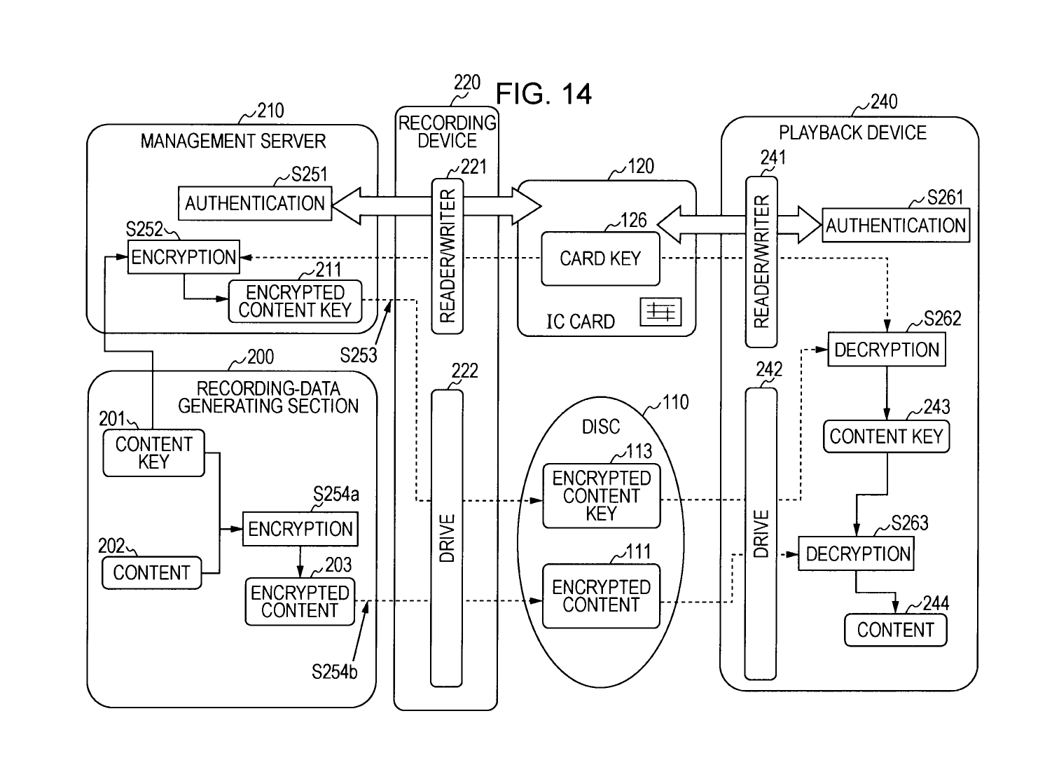

Next, referring to FIG. 14, a description will be given of an embodiment in which when recording content onto the disc 110, a process of reading a card-unique card key recorded on the IC card 120 and encrypting a content key with the card key is executed, thereby generating an encrypted content key, and the encrypted content key is recorded onto the disc. When playing back content from the disc 110, processing using the card key recorded on the IC card 120 is performed.

As in the above-mentioned embodiments, FIG. 14 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 14, a card key 126 is stored on the IC card 120 in advance. That is, the IC card is provided to the user in a state with the card-unique key stored in advance.

Referring to FIG. 14, content recording and content playback according to this embodiment will be described.

First, content recording will be described.

When recording content onto the disc 110, the user inserts the disc 110 in the drive 222 of the recording device 220, and sets the IC card 120 in the reader/writer 221 of the recording device 220.

In step S251 shown in FIG. 14, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S252, the management server 210 uses a card key read from the IC card 120 to execute encryption of the content key 201 generated by the recording-data generating section 200, generating an encrypted content key 211. In step S253, the generated encrypted content key 211 is provided to the recording device 220, and written onto the disc 110 via the drive 222 of the recording device 220. As shown in FIG. 14, the encrypted content key 113 is stored onto the disc 110.

Next, recording of data generated by the recording-data generating section 200 onto the disc 110 is executed. This process corresponds to each of steps S254a and S254b shown in FIG. 14. First, in step S254a, encryption of the content 202 is performed by using the content key 201, generating the encrypted content 203. Next, in step S254b, the encrypted content 203 is provided to the recording device 220, and the recording device 220 writes the encrypted content onto the disc 110 via the drive 222. Obtained as a result of this writing is the encrypted content 111 shown inside the disc 110 in FIG. 14.

It is not necessary for the recording-data generating section 200 to encrypt content with a content key to generate encrypted content every time such a request is made from the user. Such content key and encrypted content may be reused, or may be prepared in advance.

Next, referring to FIG. 14, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S261 shown in FIG. 14, mutual authentication between the IC card 120 and the playback device 240 is executed. The mutual authentication between the IC card 120 and the playback device 240 is performed via the reader/writer 241. If this mutual authentication is not established, the subsequent processing is cancelled.

If mutual authentication is established and it is determined that both parties can trust each other, in step S262, the playback device 240 reads a card key from the IC card 120, and executes decryption of the encrypted content key 113 acquired from the disc 110. The playback device 240 acquires the content key 243 through decryption using the card key.

Next, as shown in FIG. 14, in step S263, the playback device 240 reads the encrypted content 111 recorded on the disc 110 via the drive 242, and executes decryption using the content key 243 on the encrypted content, thereby acquiring and playing back the content 244.

According to this embodiment, content playback is possible by using a card-unique card key. It should be noted that use of a single card key enables use of various disc-stored contents. Parallel uses of a plurality of contents are also possible.

[9. Embodiment in which a Card Key and Content Information are Recorded onto an IC Card (Embodiment 7)]

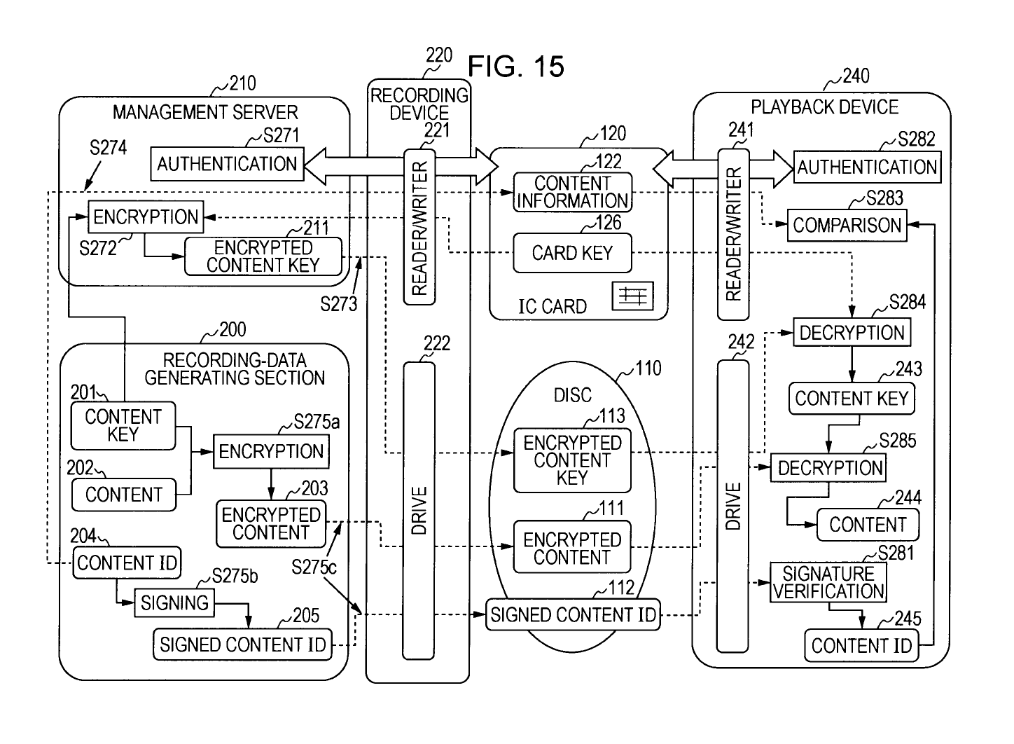

Next, referring to FIG. 15, a description will be given of an embodiment in which content information is combined with the above-mentioned process using a card key.

As in the above-mentioned embodiments, FIG. 15 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 15, content information is recorded on the IC card 120. The content information contains a content ID as a content identifier. Referring to FIG. 15, content recording and content playback according to this embodiment will be described. First, content recording will be described.

When recording content onto the disc 110, the user inserts the disc 110 in the drive 222 of the recording device 220, and sets the IC card 120 in the reader/writer 221 of the recording device 220.

In step S271 shown in FIG. 15, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S272, the management server 210 uses a card key read from the IC card 120 to execute encryption of the content key 201 generated by the recording-data generating section 200, generating the encrypted content key 211. In step S273, the generated encrypted content key 211 is provided to the recording device 220, and written onto the disc 110 via the drive 222 of the recording device 220. As shown in FIG. 15, the encrypted content key 113 is stored onto the disc 110.

Next, in step S274, the management server 210 provides the content ID 204 generated by the recording-data generating section 200 to the recording device 220. The recording device 220 records the content information 122 in which the content ID is stored, onto the IC card 120 via the reader/writer 221.

Next, recording of data generated by the recording-data generating section onto the disc 110 is executed. This process corresponds to each of steps S275a to S275c shown in FIG. 15. First, in step S254a, encryption of the content 202 is performed by using the content key 201, generating the encrypted content 203. Next, in step S275b, generation of a signature is executed with respect to the content ID 204, generating the signed content ID 205.

Next, in step S275c, the encrypted content 203 and the signed content ID 205 are provided to the recording device 220, and the recording device 220 writes these pieces of data onto the disc 110 via the drive 222. Obtained as a result of this writing are the encrypted content 111 and the signed content ID 205 shown inside the disc 110 in FIG. 15.

It is not necessary for the recording-data generating section 200 to encrypt content with a content key to generate encrypted content, and perform signing of a content ID to generate a signed content ID every time such a request is made from the user. Such content key, encrypted content, content ID, and signed content ID may be reused, or may be prepared in advance.

Next, referring to FIG. 15, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S281 shown in FIG. 15, the playback device 240 reads the signed content ID 112 from the disc 110 via the drive 242 of the playback device 240, and performs signature verification. This is a process of confirming whether or not data tempering has been done on the content ID 112. In FIG. 15, a content ID that has been confirmed by the signature verification as being free of tampering is indicated as the content ID 245.

If it is not determined in the signature verification that no tampering has been done, the subsequent processing is cancelled. That is, content playback is not executed in this case. On the other hand, if it is determined in the signature verification that no tampering has been done, as indicated by step S282, mutual authentication between the IC card 120 and the playback device 240 is executed in this case. The mutual authentication between the IC card 120 and the playback device 240 is performed via the reader/writer 241. If this mutual authentication is not established, the subsequent processing is cancelled.

If mutual authentication is established and it is determined that both parties can trust each other, the playback device 240 reads the content information 122 from the IC card 120, and compares a content ID in the content information with the content ID read from the disc 110. This process corresponds to the process in step S283 shown in FIG. 15.

If the two content IDs do not match in this comparison, the subsequent processing is cancelled. If the content IDs match in the ID comparison, the playback device 240 reads the card key 126 recorded on the IC card 120 via the reader/writer 241. Further, in step S284, the playback device 240 reads an encrypted content key from the disc via the drive of the playback device, and performs decryption using the card key to acquire the content key 243. Next, in step S285, the playback device 240 reads encrypted content from the disc via the drive of the playback device, performs decryption with the content key 243, thereby acquiring the content 244 for content playback.

While the above-mentioned processing example is directed to the case in which only a content ID is stored in the content information, a setting may be employed which stores a usage status flag corresponding to each content, so that only those contents whose usage status flags indicate a valid value can be used. Under this setting, the playback device executes a process of checking the value of the flag of content corresponding to the disc-stored content to be used, and performs decryption and playback only when the flag is set to a valid value.

[10. Embodiment in which a Card Key and a Content ID List are Recorded onto an IC Card, and an Encrypted Content Key Encrypted with the Card Key is Recorded onto a Disc (Embodiment 8)]

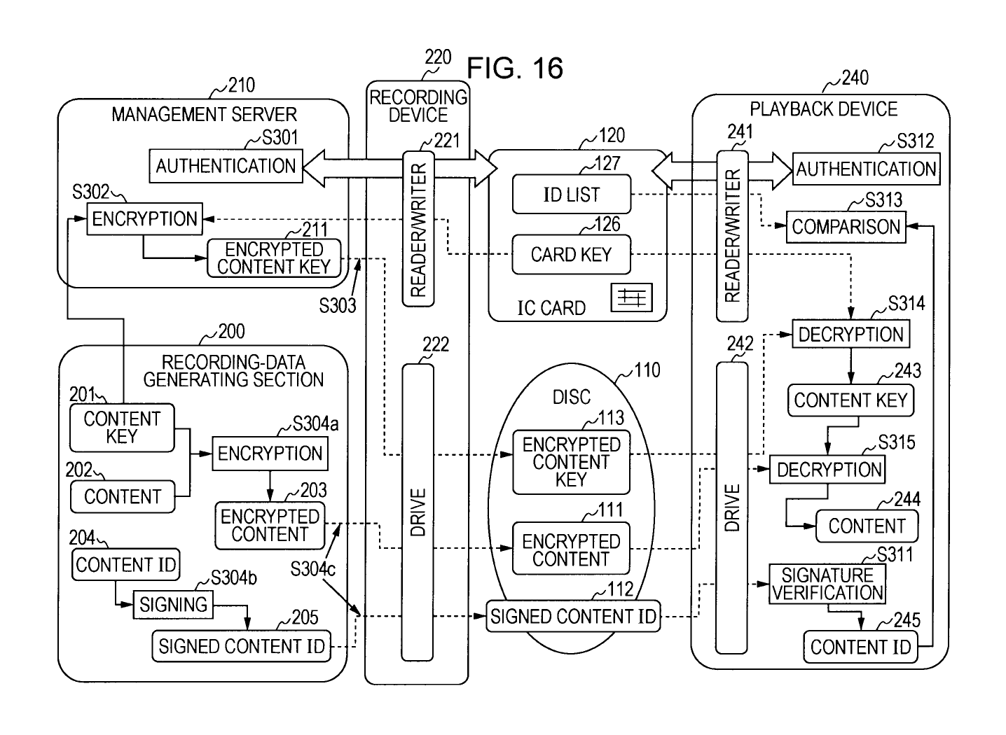

Next, referring to FIG. 16, a description will be given of an embodiment in which, in addition to the process using a card key described above with reference to FIG. 14, the content ID of the content being used in the playback device is written into an ID list in the IC card, and an encrypted content key encrypted with the card key is recorded onto the disc.

As in the above-mentioned embodiments, FIG. 16 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 16, an ID list 127 is set in the IC card 120. A content ID corresponding to the content being used in the playback device 240 is written into the ID list 127. After finishing use, the playback device 240 performs a process of erasing from the ID list 127 the content ID of the content of which use is finished. By this process, overlapping use of the same content on the same disc by different playback devices is prevented.

Referring to FIG. 16, content recording and content playback according to this embodiment will be described. First, content recording will be described.

When recording content onto the disc 110, the user inserts the disc 110 in the drive 222 of the recording device 220, and sets the IC card 120 in the reader/writer 221 of the recording device 220.

In step S301 shown in FIG. 16, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S302, the management server 210 uses a card key read from the IC card 120 to execute encryption of the content key 201 generated by the recording-data generating section 200, generating the encrypted content key 211. In step S303, the generated encrypted content key 211 is provided to the recording device 220, and written onto the disc 110 via the drive 222 of the recording device 220. As shown in FIG. 16, the encrypted content key 113 is stored onto the disc 110.

Next, recording of data generated by the recording-data generating section onto the disc 110 is executed. This process corresponds to each of steps S304a to S304c shown in FIG. 16. First, in step S304a, encryption of the content 202 is performed by using the content key 201, generating the encrypted content 203. Next, in step S304b, generation of a signature is executed with respect to the content ID 204, generating the signed content ID 205.

Next, in step S304c, the encrypted content 203 and the signed content ID 205 are provided to the recording device 220, and the recording device 220 writes these pieces of data onto the disc 110 via the drive 222. Obtained as a result of this writing are the encrypted content 111 and the signed content ID 112 shown inside the disc 110 in FIG. 16.

It is not necessary for the recording-data generating section 200 to encrypt content with a content key to generate encrypted content, and perform signing of a content ID to generate a signed content ID every time such a request is made from the user. Such content key, encrypted content, content ID, and signed content ID may be reused, or may be prepared in advance.

Next, referring to FIG. 16, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S311 shown in FIG. 16, the playback device 240 reads the signed content ID 112 from the disc 110 via the drive 242 of the playback device 240, and performs signature verification. This is a process of confirming whether or not data tempering has been done on the content ID 112. In FIG. 16, a content ID that has been confirmed by the signature verification as being free of tampering is indicated as the content ID 245.

If it is not determined in the signature verification that no tampering has been done, the subsequent processing is cancelled. That is, content playback is not executed in this case. On the other hand, if it is determined in the signature verification that no tampering has been done, as indicated by step S312, mutual authentication between the IC card 120 and the playback device 240 is executed in this case. The mutual authentication between the IC card 120 and the playback device 240 is performed via the reader/writer 241. If this mutual authentication is not established, the subsequent processing is cancelled.

If mutual authentication is established and it is determined that both parties can trust each other, the playback device 240 reads the ID list 127 from the IC card 120, and compares content IDs recorded in the ID list 127 with the content ID read from the disc 110. This process corresponds to the process in step S313 shown in FIG. 16.

If it is confirmed in this comparison that the content ID read from the disc 110 is registered in the ID list 127 recorded on the IC card 120, this indicates that the corresponding disc-recorded content is being used on another playback device. In this case, the subsequent processing is cancelled. That is, content playback is not performed.

On the other hand, if it is confirmed that the content ID read from the disc 110 is not registered in the ID list 127 recorded on the IC card 120, this indicates that the corresponding disc-recorded content is not being used on another playback device. In this case, the subsequent processing is performed.

In this case, the playback device 240 reads the card key 126 recorded on the IC card 120 via the reader/writer 241. Further, in step S314, the playback device 240 reads an encrypted content key from the disc via the drive of the playback device, and performs decryption using the card key to acquire the content key 243. Next, in step S315, the playback device 240 reads encrypted content from the disc via the drive of the playback device, performs decryption with the content key 243, thereby acquiring the content 244 for content playback.

It should be noted that although not shown, upon finishing content playback, the playback device 240 executes mutual authentication with the IC card again, and on the condition that the mutual authentication is established, the playback device 240 executes a process of erasing from the ID list 127 the content ID of the content of which use is finished.

With this configuration, overlapping use of the same content stored on a single disc by a plurality of playback devices is prevented. While the above-mentioned processing example is directed to the case in which the ID to be recorded onto the disc is a signed content ID, instead of a content ID, a media ID for identifying each disc may be used to store a signed media ID. In this case, the media ID is also recorded on the ID list that is recorded onto the IC card.

[11. Embodiment in which a Card Key Recorded on an IC Card is used to Record an Encrypted Volume Key Encrypted with the Card Key onto a Disc (Embodiment 9)]

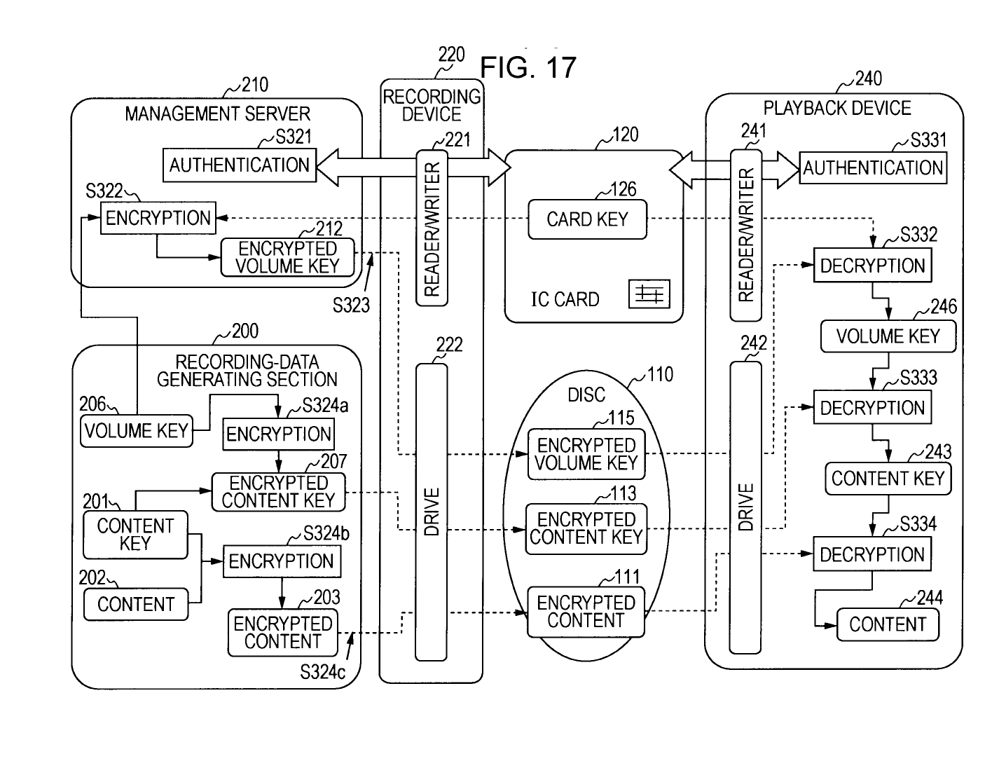

Next, referring to FIG. 17, a description will be given of an embodiment in which when recording content onto the disc 110, a process of reading a card-unique card key recorded on the IC card 120 and encrypting a volume key with the card key is executed, thereby generating an encrypted volume key, and the encrypted volume key is recorded onto the disc. When playing back content from the disc 110, processing using the card key recorded on the IC card 120 is performed. It should be noted that, as previously mentioned, one volume key is set in correspondence to a plurality of contents and content keys.

As in the above-mentioned embodiments, FIG. 17 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 17, the card key 126 is stored on the IC card 120 in advance. That is, the IC card is provided to the user in a state with a card-unique key stored in advance.

Referring to FIG. 17, content recording and content playback according to this embodiment will be described.

First, content recording will be described.

When recording content onto the disc 110, the user inserts the disc 110 in the drive 222 of the recording device 220, and sets the IC card 120 in the reader/writer 221 of the recording device 220.

In step S321 shown in FIG. 17, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S322, the management server 210 uses a card key read from the IC card 120 to execute encryption of the volume key 206 generated by the recording-data generating section 200, generating an encrypted volume key 212. In step S323, the generated encrypted volume key 212 is provided to the recording device 220, and written onto the disc 110 via the drive 222 of the recording device 220. As shown in FIG. 17, an encrypted volume key 115 is stored onto the disc 110.

Next, recording of data generated by the recording-data generating section 200 onto the disc 110 is executed. This process corresponds to each of steps S324a to S324c shown in FIG. 17. First, in step S324a, encryption of the content key 201 is performed by using the volume key 206, generating the encrypted content key 207.

Further, in step S324b, encryption of the content 202 is performed by using the content key 201, generating the encrypted content 203. Next, in step S324c, the encrypted content key 207 and the encrypted content 203 are provided to the recording device 220, and the recording device 220 writes these pieces of data onto the disc 110 via the drive 222. Obtained as a result of this writing are the encrypted content key 113 and the encrypted content 111 shown inside the disc 110 in FIG. 17.

It is not necessary for the recording-data generating section 200 to encrypt content with a content key to generate encrypted content, and encrypt the content key with a volume key to generate an encrypted content key every time such a request is made from the user. Such encrypted content, volume key, and encrypted content key may be reused, or may be prepared in advance.

Next, referring to FIG. 17, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S331 shown in FIG. 17, mutual authentication between the IC card 120 and the playback device 240 is executed. The mutual authentication between the IC card 120 and the playback device 240 is performed via the reader/writer 241. If this mutual authentication is not established, the subsequent processing is cancelled.

If mutual authentication is established and it is determined that both parties can trust each other, in step S332, the playback device 240 reads a card key from the IC card 120, and executes decryption of the encrypted volume key 115 acquired from the disc 110. The playback device 240 acquires the volume key 246 through decryption using the card key. Further, in step S333, the playback device 240 executes decryption of the encrypted content key 113 acquired from the disc 110, generating the content key 243.

Next, as shown in FIG. 17, in step S334, the playback device 240 reads the encrypted content 111 recorded on the disc 110 via the drive 242, and executes decryption using the content key 243 on the encrypted content, thereby acquiring and playing back the content 244.

[12. Embodiment in which a Card Key and Volume Information are Recorded onto an IC Card (Embodiment 10)]

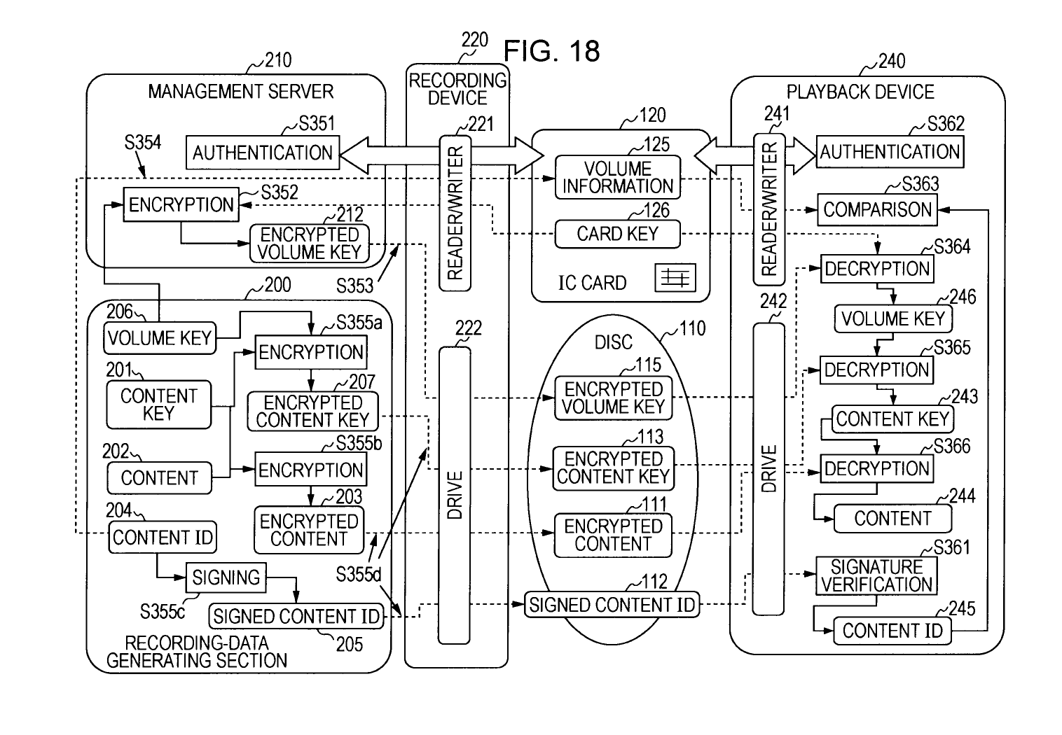

Next, referring to FIG. 18, a description will be given of an embodiment that combines volume information with the above-mentioned process using a card key.

As in the above-mentioned embodiments, FIG. 18 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 18, volume information is recorded onto the IC card 120. As previously mentioned, the volume information contains a volume ID, and content usage status flags of individual contents corresponding to each volume.

As previously mentioned, a volume key is set in correspondence to a plurality of contents and content keys. For example, a volume key Kv corresponding to a set of the following is set.

Content A/content key A

Content B/content key B

Content C/content key C

In the case of this setting, the volume information contains content IDs corresponding to the three contents A to C. Alternatively, these three content IDs, and usage status flags corresponding to the three contents A to C are set.

Referring to FIG. 18, content recording and content playback according to this embodiment will be described. First, content recording will be described.

When recording content onto the disc 110, the user inserts the disc 110 in the drive 222 of the recording device 220, and sets the IC card 120 in the reader/writer 221 of the recording device 220.

In step S351 shown in FIG. 18, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S352, the management server 210 uses a card key read from the IC card 120 to execute encryption of the volume key 206 generated by the recording-data generating section 200, generating the encrypted volume key 212. In step S353, the generated encrypted volume key 212 is provided to the recording device 220, and written onto the disc 110 via the drive 222 of the recording device 220. As shown in FIG. 18, the encrypted volume key 115 is stored onto the disc 110.

Next, in step S354, the management server 210 provides the content ID 204 generated by the recording-data generating section 200 to the recording device 220. The recording device 220 records the volume information 125 in in which the content ID is stored, onto the IC card 120 via the reader/writer 221.

Next, recording of data generated by the recording-data generating section onto the disc 110 is executed. This process corresponds to each of steps S355a to S355d shown in FIG. 18. First, in step S355a, encryption of the content key 201 is performed by using the volume key 206, generating the encrypted content key 207.

Next, in step S355b, encryption of the content 202 is performed by using the content key 201, generating the encrypted content 203. Next, in step S355c, generation of a signature is executed with respect to the content ID 204, generating the signed content ID 205.

Next, in step S355d, the encrypted content key 207, the encrypted content 203, and the signed content ID 205 are provided to the recording device 220, and the recording device 220 records these pieces of data onto the disc 110 via the drive 222. Obtained as a result of this recording are the encrypted content key 113, the encrypted content 111, and the signed content ID 112 shown inside the disc 110 in FIG. 18.

It is not necessary for the recording-data generating section 200 to encrypt content with a content key to generate encrypted content, encrypt the content key with a volume key to generate an encrypted content key, and perform signing of a content ID to generate a signed content ID every time such a request is made from the user. Such encrypted content, volume key, encrypted content key, content ID, and signed content ID may be reused, or may be prepared in advance.

Next, referring to FIG. 18, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S361 shown in FIG. 18, the playback device 240 reads the signed content ID 112 from the disc 110 via the drive 242 of the playback device 240, and performs signature verification. This is a process of confirming whether or not data tempering has been done on the content ID 112. In FIG. 18, a content ID that has been confirmed by the signature verification as being free of tampering is indicated as the content ID 245.

If it is not determined in the signature verification that no tampering has been done, the subsequent processing is cancelled. That is, content playback is not executed in this case. On the other hand, if it is determined in the signature verification that no tampering has been done, as indicated by step S362, mutual authentication between the IC card 120 and the playback device 240 is executed in this case. The mutual authentication between the IC card 120 and the playback device 240 is performed via the reader/writer 241. If this mutual authentication is not established, the subsequent processing is cancelled.

If mutual authentication is established and it is determined that both parties can trust each other, the playback device 240 reads the volume information 125 from the IC card 120, and compares content IDs in the volume information 125 with the content ID read from the disc 110. This process corresponds to the process in step S363 shown in FIG. 18.

If the two content IDs do not match in this comparison, the subsequent processing is cancelled. If the content IDs match in the ID comparison, the playback device 240 reads the card key 126 recorded on the IC card 120 via the reader/writer 241. Further, in step S364, the playback device 240 reads an encrypted volume key from the disc via the drive of the playback device, and performs decryption using the card key to acquire the volume key 246.

Next, in step S365, the playback device 240 reads an encrypted content key from the disc via the drive of the playback device, and performs decryption with the volume key 246 to acquire the content key 243. Next, in step S366, the playback device 240 reads encrypted content from the disc via the drive of the playback device, performs decryption by using the content key 243, thereby acquiring the content 244 for content playback.

While the above-mentioned processing example is directed to the case in which only content IDs are stored in the volume information, a setting may be employed which stores usage status flags corresponding to individual contents, so that only those contents whose usage status flags indicate a valid value can be used. Under this setting, the playback device executes a process of checking the value of the flag of content corresponding to the disc-stored content to be used, and performs decryption and playback only when the flag is set to a valid value.

[13. Embodiment in which a Card Key and a Content ID List are Recorded onto an IC Card, and an Encrypted Volume Key Encrypted with the Card Key is Recorded onto a Disc (Embodiment 11)]

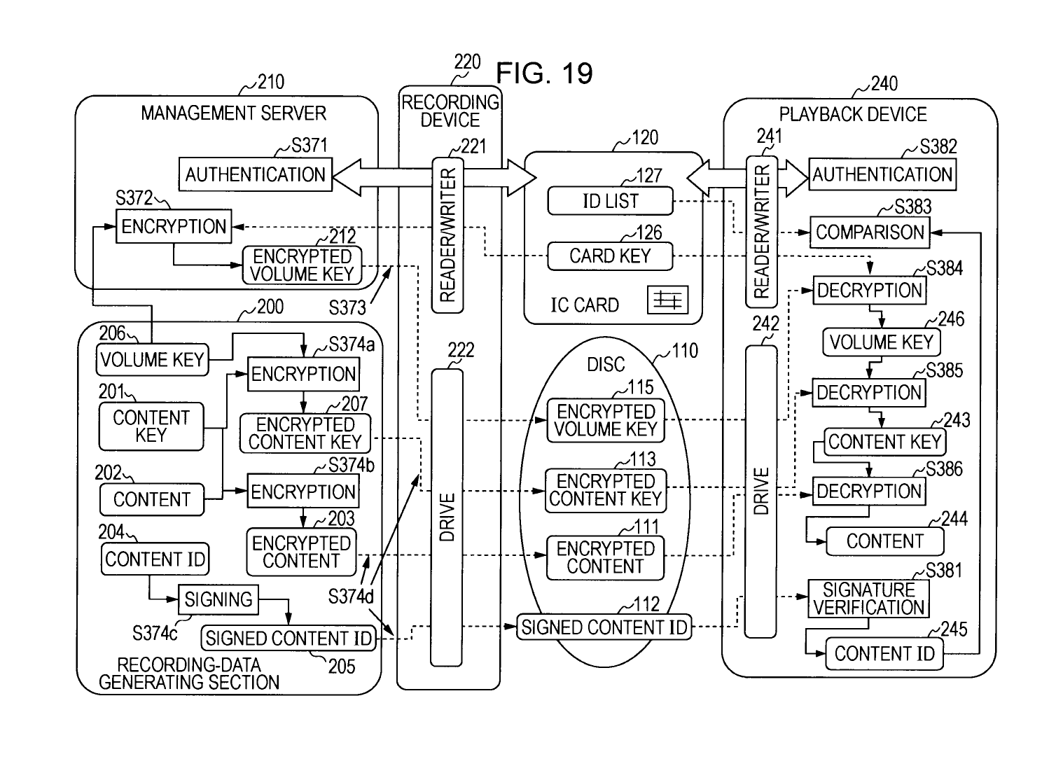

Next, referring to FIG. 19, a description will be given of an embodiment in which, in addition to the process using a card key described above with reference to FIG. 17, the content ID of the content being used in the playback device is written into an ID list in the IC card, and an encrypted volume key encrypted with the card key is recorded onto the disc.

As in the above-mentioned embodiments, FIG. 19 shows the following components: the disc 110; the IC card 120; the management server 210; the recording-data generating section 200; the recording device (recorder) 220; and the playback device (player) 240. The basic configurations and connections of the individual devices are the same as those described above with reference to FIG. 4.

In this embodiment, as shown in FIG. 19, the ID list 127 is set in the IC card 120. A content ID corresponding to the content being used in the playback device 240 is written into the ID list 127. After finishing use, the playback device 240 performs a process of erasing from the ID list 127 the content ID of the content of which use is finished. By this process, overlapping use of the same content on the same disc by different playback devices is prevented.

Referring to FIG. 19, content recording and content playback according to this embodiment will be described. First, content recording will be described.

When recording content onto the disc 110, the user inserts the disc 110 in the drive 222 of the recording device 220, and sets the IC card 120 in the reader/writer 221 of the recording device 220.

In step S371 shown in FIG. 19, mutual authentication between the IC card 120 and the management server 210 is executed. The mutual authentication is performed via the recording device 220. If this mutual authentication is not established, the subsequent processing is cancelled.

If mutual authentication is established and it is determined that both parties can trust each other, in step S372, the management server 210 uses a card key read from the IC card 120 to execute encryption of the volume key 206 generated by the recording-data generating section 200, generating the encrypted volume key 212. In step S373, the generated encrypted volume key 212 is provided to the recording device 220, and written onto the disc 110 via the drive 222 of the recording device 220. As shown in FIG. 19, the encrypted volume key 115 is stored onto the disc 110.

Next, recording of data generated by the recording-data generating section onto the disc 110 is executed. This process corresponds to each of steps S374a to S374d shown in FIG. 19. First, in step S374a, encryption of the content key 201 is performed by using the volume key 206, generating the encrypted content key 207.

Next, in step S374b, encryption is performed on the content 202 by using the content key 201, generating the encrypted content 203. Next, in step S374c, generation of a signature is executed with respect to the content ID 204, generating the signed content ID 205.

Next, in step S374d, the encrypted content key 207, the encrypted content 203, and the signed content ID 205 are provided to the recording device 220, and the recording device 220 records these pieces of data onto the disc 110 via the drive 222. Obtained as a result of this recording are the encrypted content key 113, the encrypted content 111, and the signed content ID 112 shown inside the disc 110 in FIG. 19.

It is not necessary for the recording-data generating section 200 to encrypt content with a content key to generate encrypted content, encrypt the content key with a volume key to generate an encrypted content key, and perform signing of a content ID to generate a signed content ID every time such a request is made from the user. Such encrypted content, volume key, encrypted content key, and signed content ID may be reused, or may be prepared in advance.

Next, referring to FIG. 19, a description will be given of a sequence in the case of using content recorded on the disc 110.

When playing pack content recorded on the disc 110, the user inserts the disc 110 in the drive 242 of the playback device 240, and sets the IC card 120 in the reader/writer 241 of the playback device 240.

In step S381 shown in FIG. 19, the playback device 240 reads the signed content ID 112 from the disc 110 via the drive 242 of the playback device 240, and performs signature verification. This is a process of confirming whether or not data tempering has been done on the content ID 112. In FIG. 19, a content ID that has been confirmed by the signature verification as being free of tampering is indicated as the content ID 245.

If it is not determined in the signature verification that no tampering has been done, the subsequent processing is cancelled. That is, content playback is not executed in this case. On the other hand, if it is determined in the signature verification that no tampering has been done, as indicated by step S382, mutual authentication between the IC card 120 and the playback device 240 is executed in this case. The mutual authentication between the IC card 120 and the playback device 240 is performed via the reader/writer 241. If this mutual authentication is not established, the subsequent processing is cancelled.

If mutual authentication is established and it is determined that both parties can trust each other, the playback device 240 reads the ID list 127 from the IC card 120, and compares content IDs recorded in the ID list 127 with the content ID read from the disc 110. This process corresponds to the process in step S383 shown in FIG. 19.

If it is confirmed in this comparison that the content ID read from the disc 110 is registered in the ID list 127 recorded on the IC card 120, this indicates that the corresponding disc-recorded content is being used on another playback device. In this case, the subsequent processing is cancelled. That is, content playback is not performed.

On the other hand, if it is confirmed that the content ID read from the disc 110 is not registered in the ID list 127 recorded on the IC card 120, this indicates that the corresponding disc-recorded content is not being used on another playback device. In this case, the subsequent processing is performed.

In this case, the playback device 240 reads the card key 126 recorded on the IC card 120 via the reader/writer 241. Further, in step S384, the playback device 240 reads an encrypted volume key from the disc via the drive of the playback device, and performs decryption using the card key to acquire the volume key 246.

Next, in step S385, the playback device 240 reads an encrypted content key from the disc via the drive of the playback device, and performs decryption with the volume key to acquire the content key 243. Next, in step S386, the playback device 240 reads encrypted content from the disc via the drive of the playback device, performs decryption by using the content key 243, thereby acquiring the content 244 for content playback.

It should be noted that although not shown, upon finishing content playback, the playback device 240 executes mutual authentication with the IC card again, and on the condition that the mutual authentication is established, the playback device 240 executes a process of erasing from the ID list 127 the content ID of the content of which use is finished.

With this configuration, overlapping use of the same content stored on a single disc by a plurality of playback devices is prevented. While the above-mentioned processing example is directed to the case in which the ID to be recorded onto the disc is a signed content ID, instead of a content ID, a media ID for identifying each disc may be used to store a signed media ID. In this case, the media ID is also recorded on the ID list that is recorded onto the IC card.

The present invention has been described above in detail with reference to specific embodiments. However, it is obvious that a person skilled in the art can make various modifications to and substitutions for the embodiments without departing from the scope of the present invention. That is, the present invention has been disclosed by way of examples, and should not be construed restrictively. The scope of the present invention should be determined with reference to the appended claims.

The series of processes described in this specification can be executed by hardware, software, or a composite configuration of both. If the processes are to be executed by software, the processes can be executed by installing a program recording the processing sequence into a memory in a computer embedded in dedicated hardware, or by installing the program into a general purpose computer capable of executing various processes. For example, the program can be pre-recorded on a recording medium. Other than being installed into a computer from a recording medium, the program can be received via a network such as the LAN (Local Area Network) or the Internet, and installed into a built-in recording medium such as a hard disk.

The various processes described in this specification may be executed not only time sequentially in the order as they appear in the description but may be executed in parallel or independently depending on the throughput of the device executing the processes or as necessary. Further, the term system as used in this specification refers to a logical collection of a plurality of devices, and is not limited to one in which individual devices are located within the same housing.

According to an embodiment of the present invention, encrypted content is recorded onto a disc, and data to be used for the encrypted content, for example, a content key, is recorded onto an IC card. Recording of data onto the IC card is allowed on the condition that mutual authentication with a management server is established. In addition, reading of data such as the content key recorded on the IC card is allowed on the condition that mutual authentication between a playback device and the IC card is established. With this configuration, it is possible to prevent unauthorized use of content, and perform appropriate content usage control in the case of a configuration in which content is recorded onto an arbitrary disc having no special identification information.

The present application contains subject matter related to that disclosed in Japanese Priority Patent Application JP 2009-052854 filed in the Japan Patent Office on Mar. 6, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
an authentication section that executes authentication with a first recording medium; and
a decryption section that executes decryption of encrypted data stored on a second recording medium,
wherein the decryption section acquires data stored on the first recording medium on a condition that authentication with the first recording medium is established, and performs decryption of encrypted data recorded on the second recording medium by using the acquired data.

2. The information processing apparatus according to claim 1, wherein:
the first recording medium is an IC card or a USB token; and
the second recording medium is a disc on which encrypted content is recorded.

3. The information processing apparatus according to claim 1 or 2, wherein:
the second recording medium stores encrypted content, and identification information of the encrypted content;
the first recording medium stores identification information of the encrypted content;
the information processing apparatus executes a comparison of the identification information acquired from both the first recording medium and the second recording medium; and
the decryption section performs decryption of encrypted content recorded on the second recording medium, on a condition that both the identification information match.

4. The information processing apparatus according to claim 3, wherein:
a signature is set for the identification information of the encrypted content stored on the second recording medium; and
the information processing apparatus performs verification of the signature, and performs the comparison if it is confirmed that the identification information is data that has not been tampered with.

5. The information processing apparatus according to claim 1 or 2, wherein:
the first recording medium stores a usage status flag indicating a usage status of data recorded on the second recording medium in the information processing apparatus; and
the information processing apparatus determines whether or not the usage status flag is set to a valid value indicating a state in which use of the data recorded on the second recording medium by the information processing apparatus is permitted, and performs decryption of encrypted content recorded on the second recording medium on a condition that setting of the valid value is confirmed.

6. The information processing apparatus according to claim 1 or 2, wherein:
the second recording medium stores encrypted content;
the first recording medium stores a content key used for decryption of the encrypted content; and
the decryption section performs decryption of the encrypted content by using the content key.

7. The information processing apparatus according to claim 1 or 2, wherein:
the second recording medium stores encrypted content, and an encrypted content key that is encrypted data of a content key used for decryption of the encrypted content;
the first recording medium stores a volume key used for decryption of a plurality of encrypted content keys including the encrypted content key; and
the decryption section acquires the content key through decryption of the encrypted content key by using the volume key, and performs decryption of the encrypted content by using the acquired content key.

8. The information processing apparatus according to claim 1 or 2, wherein:
the second recording medium stores encrypted content, and an encrypted content key that is encrypted data of a content key used for decryption of the encrypted content;
the first recording medium stores a card key used for decryption of a plurality of encrypted content keys including the encrypted content key; and
the decryption section acquires the content key through decryption of the encrypted content key by using the card key, and performs decryption of the encrypted content by using the acquired content key.

9. A data recording system comprising:
a recording-data generating section that generates data to be recorded onto a disc;
a management server that executes mutual authentication with an IC card or a USB token; and
a recording device that performs recording of data onto the disc and the IC card or the USB token,
wherein the management server executes authentication with the IC card or the USB token inserted in the recording device, and on a condition that the authentication is established, the management server provides the recording device with data used for decryption of encrypted data to be recorded onto the disc, and
the recording device records the data provided by the management server onto the IC card or the USB token, on a condition that the authentication is established.

10. The data recording system according to claim 9, wherein on a condition that the authentication is established, the management server provides the recording device with a content key used for decryption of encrypted content recorded onto the disc, as data to be recorded onto the IC card or the USB token.

11. The data recording system according to claim 9, wherein on a condition that the authentication is established, the management server provides the recording device with identification information of encrypted content recorded onto the disc, as data to be recorded onto the IC card or the USB token.

12. The data recording system according to claim 9, wherein on a condition that the authentication is established, the management server provides the recording device with flag data for controlling use of encrypted content recorded onto the disc, as data to be recorded onto the IC card or the USB token.

13. The data recording system according to claim 9, wherein on a condition that the authentication is established, the management server acquires a card key stored on the IC card or the USB token, uses the card key to execute encryption of an encryption key used for decryption of encrypted content recorded onto the disc, and provides the recording device with the encrypted encryption key as data to be recorded onto the disc.

14. An information processing method executed by an information processing apparatus, comprising the steps of:
an authentication section executing authentication with a first recording medium; and
a decryption section executing decryption of encrypted data stored on a second recording medium,
wherein the executing of decryption includes acquiring data stored on the first recording medium on a condition that authentication with the first recording medium is established, and performing decryption of encrypted data recorded on the second recording medium by using the acquired data.

15. A program for causing an information processing apparatus to execute information processing comprising the steps of:
an authentication section executing authentication with a first recording medium; and
a decryption section executing decryption of encrypted data stored on a second recording medium,
wherein the executing of decryption includes acquiring data stored on the first recording medium on a condition that authentication with the first recording medium is established, and performing decryption of encrypted data recorded on the second recording medium by using the acquired data.
